(19) United States
(12) Patent Application Publication
(10) Pub. No.: US 2023/0007452 A1
(43) Pub. Date: Jan. 5, 2023

(54) SENSOR DEVICE, COMMUNICATION NODE, SYSTEM AND METHODS FOR DETERMINING WHICH MOBILE COMMUNICATION DEVICE IS CLOSEST TO A SENSOR DEVICE

(71) Applicant: Shortcut Labs AB, Stockholm (SE)

(72) Inventors: Joacim WESTLUND PRÄNDEL, Stockholm (SE); Anton MEIER, Stockholm (SE); Emil LENNGREN, Stockholm (SE); Oskar ÖBERG, Stockholm (SE)

(73) Assignee: Shortcut Labs AB, Stockholm (SE)

(21) Appl. No.: 17/611,683

(22) PCT Filed: May 15, 2020
(86) PCT No.: PCT/SE2020/050506

§ 371 Date: Nov. 16, 2021

(30) Foreign Application Priority Data
May 17, 2019 (SE) 1950595-7

(51) Int. Cl. H04W 4/38; H04W 4/80; H04W 4/02

(52) U.S. Cl. CPC H04W 4/38; H04W 4/80; H04W 4/023

(57) ABSTRACT

The technology disclosed relates to methods, a sensor device, a communication node and a system for providing a user associated with a mobile communication device with information by determining which user is closest to the sensor device at least partly based on at least one of the determined signal strength of a broadcast signal and a distance measurement by phase of a plurality of broadcast signals having different frequencies received by the mobile communication device of the user determined to be closest to the sensor device.

### TECHNICAL FIELD

The technology disclosed relates to methods, a sensor device, a communication node and a system.

In aspects, the technology disclosed relates to methods, a sensor device, a communication node and/or a system for determining which mobile communication device, and associated user, is currently closest to a sensor device at least partly based on a determined signal strength of a broadcast signal sent from the sensor device and which is received by at least one mobile communication device, or at least partly based on a distance measurement determined by means of phase.

In certain aspects, the technology disclosed relates to methods, a sensor device, a communication node and/or a system for determining which user activated an input means of a sensor device based on a determined signal strength of a broadcast signal sent from the sensor device and which is received by at least one mobile communication device, including the mobile communication device of the user who activated the input device.

In certain aspects, the technology disclosed relates to methods, a sensor device, a communication node and a system for alerting a user of a mobile communication device determined to be closest to the sensor device that the sensor device has obtained a pre-defined threshold value by at least one of continuously measuring, detecting and recording. The determination of which mobile communication device is closest to the sensor device may then be at least partly based on the determination of a signal strength of a broadcast signal sent from the sensor device or at least partly based on a distance measurement determined by means of phase using a plurality of received broadcast signals/messages having different frequencies.

The technology disclosed relates to methods, a sensor device, a communication node and a system configured to allow for a simple way to obtain information associated with a sensor device, and/or provide information to the user of a mobile communication device in response to a trigger event such as the activation of input means of the sensor device or obtaining a pre-defined threshold value by at least one of continuously measuring, detecting and recording by the sensor device. The information provided may be related to a product or activity associated with the sensor device or may be information associated with the sensor device obtaining a pre-defined threshold value.

According to certain aspects of the technology disclosed, a broadcast signal, or a sequence of broadcast signals, is transmitted from a sensor device, via short-range wireless communication in response to a trigger event sensed by the sensor device. The broadcast signal may then include a unique identifier of the sensor device and the trigger event may be any of activating an input means of the sensor device, e.g. pushing a button in the sensor device by a person, or that a sensor or detector of the sensor device obtaining a pre-defined threshold value by at least one of continuously measuring, detecting and recording.

### BACKGROUND

The sensor devices known in the art may be configured to periodically sending broadcast messages to nearby user devices.

Bluetooth based push buttons known in the art are often supposed to be connected to something, e.g. a phone or a hub, in order to operate. In some applications, each button may then be unique depending on how the application program in the phone is configured and/or the hub of the system is configured. Different things may happen when the user pushes different buttons.

In certain aspects, this disclosure also relates to trigger-event based response execution.

### Problems with the Prior Art

Beacons, e.g. iBeacons, known in the art continuously transmit messages that can be read by phones and application programs. Geofencing methods include method for estimating a distance between mobile phones and each of a plurality of beacon nodes based on a received signal strength indicator of the received beacon signals. However, beacons do not typically judge which user or phone is closest to a beacon and they are not generally triggered but are rather configured for continuously transmitting.

U.S. Pat. No. 9,733,808B2 describes a sensor device that upon a trigger sends its unique device ID to a server, which decides what happens based on the device ID. The message that the sensor device sends only contains the device ID.

Proximity sensors, e.g. disclosed in US20140073262A1, may trigger alarms based on the sensors signal strength, but these sensors are always connected to a phone.

Common smart button solutions may be enough when there is only one user of a button or when a button is configured to control a third device such as a connected light bulb. When the button is pushed, the button informs so to whichever device it is connected to, but the system doesn't know who pushed the button or which mobile communication device is closest to the button.

Certain aspects of the present disclosure advantageously alleviate the problems described above by introducing a solution that allows a simple way for interacting with mobile telecommunications related services in response to trigger events such as a button press or when a sensor or detector of the sensor device obtains a pre-defined threshold value.

### SUMMARY

The technology disclosed relates to methods, a sensor device, a communication node and a system for providing a user associated with a mobile communication device with information by determining which user is closest to the sensor device at least partly based on at least one of the determined signal strength of a broadcast signal and a distance measurement by means of phase of a plurality of broadcast signals having different frequencies received by the mobile communication device of the user determined to be closest to the sensor device.

In embodiments, the technology disclosed relates to methods, a sensor device, a communication node and a system for determining which mobile communication device, and associated user, is currently closest to a sensor device at least partly based on at least one of a determined signal strength of a broadcast signal/message transmitted by the sensor device and/or at least partly based on distance measurements by means of phase using a plurality of broadcast signals/messages having different frequencies received from the sensor device, and which is/are received by a plurality of mobile communication devices.

In embodiments, the technology disclosed relates methods, a sensor device, a communication node and a system for collecting signal strengths of signals or messages transmitted in response to a trigger event and then comparing these signals strength values with at least one of other signal strength values or a pre-defined signal strength threshold value to determine which mobile communication device, and/or associated user, is closest to the sensor device.

In embodiments, the technology disclosed relates methods, a sensor device, a communication node and a system for determining distances by measurements by means of phase using a plurality of broadcast signals where the plurality of broadcast signals are transmitted by the sensor device in response to a trigger event. In certain embodiments, a distance between a mobile communication device and the sensor device which is determined by measurement by means of phase is compared with at least one of other distance for another mobile communication device determined by measurement by means of phase and a pre-defined distance threshold value in order to thereby determine which mobile communication device, and/or associated user, is closest to the sensor device.

The technology disclosed relates to methods, a sensor device, a communication node and a system for providing a user associated with a mobile communication device with information by determining which user is closest to the sensor device at least partly based on a distance measurement by means of phase of at least one broadcast signal received by the mobile communication device of the user determined to be closest to the sensor device.

In embodiments, the technology disclosed relates to methods, a sensor device, a communication node and a system configured to allow for a simple way to alert a user, obtain information associated with a sensor device and/or provide information to the user of a mobile communication device in response to a trigger event such as the activation of input means of the sensor device or obtaining a pre-defined threshold value by at least one of continuously measuring, detecting and recording by the sensor device.

In embodiments, the technology disclosed relates to methods, a sensor device, a communication node and a system for determining which mobile communication device and associated user is closest to a sensor device in a system comprising a sensor device, a communication node and at least one mobile communication device, wherein at least one broadcast signal is sent from the sensor device in response to at least one of the activation of an input means of the sensor device and a pre-defined threshold value is obtained by the sensor device, wherein the signal strength of the at least one broadcast signal is determined by at least one mobile communication device receiving the at least one broadcast signal. The determining of which mobile communication device, and associated user, is closest to the sensor device is at least partly based on the determined signal strength of the at least one broadcast signal and the at least one mobile communication device includes the mobile communication device determined to be closest to the sensor device.

In embodiments, the technology disclosed relates to methods, a sensor device, a communication node and a system for determining which mobile communication device and associated user is closest to a sensor device in a system comprising a sensor device, a communication node and at least one mobile communication device, wherein at least one broadcast signal is sent from the sensor device in response to at least one of the activation of an input means of the sensor device and a pre-defined threshold value is obtained by the sensor device, wherein a distance measurement by means of phase is determined by at least one mobile communication device receiving the at least one broadcast signal. The determining of which mobile communication device, and associated user, is closest to the sensor device is at least partly based on a distance measurement by means of phase and the at least one mobile communication device includes the mobile communication device determined to be closest to the sensor device.

In embodiments, the technology disclosed relates methods, a sensor device, a communication node and a system for determining the distance between at least one mobile communication device and a sensor device by measurement of phase using at least two broadcast signals or messages received by a mobile communication device. In embodiments, the at least two signals or messages are transmitted by the sensor device in response to a trigger event and a determined distance is compared with at least one of other determined distance or a pre-defined distance value to determine which mobile communication device, and/or associated user, is closest to the sensor device.

In embodiments, the system comprises a plurality of sensor devices where each sensor device is provided with a unique identity. Data or information for indicating the unique identity of each sensor device may then be contained in a broadcast signal transmitted by the respective sensor device or may be contained in a message sent from of a mobile communication device or communication node of the system.

In embodiments, the system further comprises a transmitting device or devices that are configured to transmit a short-range wireless broadcast signal with a predefined wake-up message that the said mobile communication devices receives and upon receiving said wake-up message, temporarily changes parameters of said mobile communication devices that allows the communication devices to listen to short-range wireless broadcast signals from said sensor devices faster than before.

According to the technology disclosed, a broadcast signal, or a sequence of broadcast signals, is transmitted from a sensor device, via short-range wireless communication in response to a trigger event sensed by the sensor device. The broadcast signal may then include a unique identifier of the sensor device and the trigger event may be any of activating an input means of the sensor device, e.g. pressing a button by a person, or that a sensor or detector of the sensor device obtaining a pre-defined threshold value by at least one of continuously measuring, detecting and recording.

In embodiments, the sensor device comprises at least one of a temperature sensor, an accelerometer, a motion sensor, a gyro, a microphone, a potentiometer, a pressure sensor and a sensor for measuring the concentration of particles in media. In embodiments, the sensor device is configured to continuously measuring, detecting and recording at least one parameter related to at least one of temperature, pressure, luminance, particles in media, movement and acceleration where an obtained pre-defined threshold value is triggering the sensor device to send at least one broadcast signal or message, e.g. a sequence of broadcast signals.

In embodiments, the technology disclosed relates to methods, a sensor device, a communication node and a system allowing for a person activating an input means of a sensor device to obtain information associated with the sensor device, e.g. obtain information related to a certain product, trademark and/or category of products associated with the sensor device.

In embodiments, the technology disclosed relates to methods, a sensor device, a communication node and a system for providing information to the user of a mobile communication device in response to obtaining a pre-defined threshold value where the pre-defined threshold value is at least one of determined, measured, detected or recorded by the sensor device.

In embodiments, the technology disclosed relates to methods, a sensor device, a communication node and a system for providing information and/or sending a message to a person who interacted with a sensor device, where the determining of which person is closest to the sensor device is at least partly based on a determined signal strength of a signal transmitted from the sensor device and received by a mobile communication device associated with a user or person.

In embodiments, the technology disclosed relates to methods, a sensor device, a communication node and a system for providing a person with product-related information by determining which person is closest to the sensor device at least partly based on the determined signal strength of a broadcast signal received by the mobile communication device of the person determined to be closest to the sensor device. The product-related information may then relate to a trademark, product or product category associated with, or logically connected to, the sensor device to which the person is determined to be closest to. In embodiments, the transmission of the broadcast signal received by the mobile communication device from the sensor device may have been triggered by the person closest to the sensor device activating an input means of the sensor device, e.g. by pressing a button of the sensor device.

In embodiments, the technology disclosed relates to methods, a sensor device, a communication node and a system for alerting a person closest to the sensor device at least partly based on determining the signal strength of a broadcast signal received by the mobile communication device of the person determined to be closest to the sensor device. The product-related information may then relate to a trademark, product or product category which is associated with, or logically connected to, the sensor device to which the person is determined to be closest to. In embodiments, the transmission of the broadcast signal received by the mobile communication device from the sensor device may have been triggered by the sensor device obtaining a pre-defined threshold value, e.g. by at least one of measuring, detecting or recording at least one parameter related to at least one of temperature, pressure, luminance, particles in medium, movement and acceleration.

In embodiments, the technology disclosed relates to a method in a system comprising a sensor device, a communication node and at least one mobile communication device, comprising:
a) transmitting, by said sensor device, at least one short-range wireless broadcast signal;
b) receiving, at one or more mobile communication devices, at least one short-range wireless broadcast signal from said sensor device;
c) determining, by each of said one or more mobile communication devices, the signal strength of at least one received short-range wireless broadcast signal;
d) sending, from each of said one or more mobile communication devices, a message including data or information indicating the respective determined signal strength of the short-range wireless broadcast signal;
e) receiving, at the communication node, said message from the respective one or more mobile communication devices; and
f) determining, by said communication node and at least partly based on the received data or information indicating the respective determined signal strength received from the one or more mobile communication devices, which mobile communication device is closest to the sensor device.

In embodiments, the technology disclosed relates to a method in a system comprising a sensor device, a communication node and at least one mobile communication device, comprising:
a) transmitting, by said sensor device, at least one short-range wireless broadcast signal;
b) receiving, by each mobile communication devices within short-range communication range with the sensor device, at least one short-range wireless broadcast signal from said sensor device;
c) determining, by each mobile communication devices within short-range communication range with the sensor device, at least one of a distance to the sensor device by measurement by means of phase using a plurality of received short-range wireless broadcast signals and the signal strength of at least one received short-range wireless broadcast signal;
d) sending, by each mobile communication devices within short-range communication range with the sensor device during/at the time interval for/of said transmission of said at least one short-range wireless broadcast signal, a message including data or information indicating the respective determined distance and/or signal strength of the short-range wireless broadcast signal;
e) receiving, at the communication node, a message from each of said mobile communication devices within short-range communication range with the sensor device during/at the time interval for/of said transmission of said at least one short-range wireless broadcast signal; and
f) determining, by said communication node and at least partly based on the received data or information indicating the respective determined distance and/or signal strength received from the mobile communication devices within short-range communication range, which mobile communication device among said mobile communication devices within short-range communication range with the sensor device, is closest to the sensor device.

In certain embodiments, the technology disclosed relates to a method for a system comprising a sensor device and at least one mobile communication device having an application program (APP) associated with the sensor device installed. The sensor device may be configured to broadcast a message and each of the at least one mobile communication device having an application program installed and activated/running are configured to send, in response to receiving at least one short-range wireless broadcast signal from the sensor device, a message including data or information indicating the respective determined distance and/or signal strength of the short-range wireless broadcast signal. Each application program that catches the broadcasted message may then be configured to send another message to the server instance including information indicating the respective determined distance and/or signal strength of the short-range wireless broadcast signal. In embodiments, the server may use an algorithm to determine which application program is closest in proximity to the sensor device.

In embodiments, the technology disclosed relates to a system comprising a sensor device, a communication node and at least one mobile communication device having an application program associated with said sensor device installed, said sensor device is configured to at least one of transmit one or a plurality of short-range wireless broadcast signals, wherein each of the at least one mobile communication device having said application program associated with the sensor device activated and which is within short-range communication range with the sensor device during/at the time interval for/of the transmission of one or a plurality of short-range wireless broadcast signals from the sensor device, is configured to:
determine at least one of a distance to the sensor device by measurement by means of phase using a plurality of received short-range wireless broadcast signals and the signal strength of the received short-range wireless broadcast signal; and
send, to the communication node, a message containing data or information indicating the determined distance measured by means of phase and/or signal strength and at least one of the unique identification data of the respective mobile communication device, the unique identification data of a user associated with the respective mobile communication device and the unique application program identifier of the respective mobile communication device; and wherein the communication node is configured to:
receive a message from the respective of said at least one mobile communication device, and identify at least one of a unique application program identifier and the unique identity of the at least one mobile communication device, wherein the communication node is further configured to determine which mobile communication device is closest to the sensor device at least partly based on data or information received in a message from the respective at least one mobile communication devices providing an indication of the determined distance measured by means of phase and/or signal strength of a short-range wireless broadcast signal.

In embodiments, the technology disclosed relates to a method in a system comprising a sensor device, a communication node and at least one mobile communication device having an application program (APP) associated with the sensor device installed, comprising:
a) transmitting, by said sensor device, at least one short-range wireless broadcast signal;
b) receiving, by each mobile communication devices within short-range communication range with the sensor device, at least one short-range wireless broadcast signal from said sensor device;
c) determining, by each mobile communication devices within short-range communication range with the sensor device, at least one of a distance to the sensor device by measurement by means of phase using a plurality of received short-range wireless broadcast signals and the signal strength of at least one received short-range wireless broadcast signal;
d) sending, by each mobile communication devices having the application program (APP) associated with the sensor device activated/running and which is within short-range communication range with the sensor device during/at the time interval for/of said transmission of said at least one short-range wireless broadcast signal, a message including data or information indicating the respective determined distance and/or signal strength of the short-range wireless broadcast signal;
e) receiving, at the communication node, a message from each of said mobile communication devices having the application program (APP) activated and which is within short-range communication range with the sensor device during/at the time interval for/of said transmission of said at least one short-range wireless broadcast signal; and
f) determining, by said communication node and at least partly based on the received data or information indicating the respective determined distance and/or signal strength received from each mobile communication devices having the application program (APP) activated and which is within short-range communication range, which mobile communication device among said within short-range communication range with the sensor device at the time of said transmission of said at least one short-range wireless broadcast signal, is closest to the sensor device.

In embodiments, the technology disclosed relates to a mobile communication device having an application program (APP) associated with a sensor device installed, said mobile communication device is configured to:
a) activate said application program (APP) associated with the sensor device;
b) receive at least one short-range wireless broadcast signal from the sensor device when the mobile communication device is within short-range communication range with the sensor device;
c) determine at least one of a distance to the sensor device by measurement by means of phase using a plurality of received short-range wireless broadcast signals and the signal strength of at least one received short-range wireless broadcast signal; and
d) send a message including data or information indicating the determined distance and/or signal strength of the short-range wireless broadcast signal to a communication node; and
e) receive a push message from the communication node, wherein said push message is associated with said sensor device.

In embodiments, the technology disclosed relates to a mobile communication device having an application program (APP) associated with a sensor device installed, said mobile communication device is configured to:
a) activate said application program (APP) associated with the sensor device;
b) receive at least one short-range wireless broadcast signal from the sensor device when the mobile communication device is within short-range communication range with the sensor device;
c) determine at least one of a distance to the sensor device by measurement by means of phase using a plurality of received short-range wireless broadcast signals and the signal strength of at least one received short-range wireless broadcast signal; and
d) send a message including data or information indicating the determined distance and/or signal strength of the short-range wireless broadcast signal to a communication node;
e) receive a connection request from the communication node for establishing a connection with the communication node; and
f) send a request confirm message to the communication node.

In embodiments, the technology disclosed relates to a mobile communication device having an application program (APP) associated with a sensor device installed, said mobile communication device is configured to:
a) activate said application program (APP) associated with the sensor device;
b) receive at least one short-range wireless broadcast signal from the sensor device when the mobile communication device is within short-range communication range with the sensor device;
c) determine at least one of a distance to the sensor device by measurement by means of phase using a plurality of received short-range wireless broadcast signals and the signal strength of the at least one received short-range wireless broadcast signal;
d) send a message including data or information indicating the determined distance and/or signal strength of the short-range wireless broadcast signal to a communication node;
e) receive a connection request from the communication node for establishing a temporary communication session with the communication node; and
f) send a request confirm message to the communication node.

In embodiments, the transmission of the at least one broadcast signal from the sensor device may have been triggered by the step of activating an input means of the sensor device, e.g. by pressing a button of the sensor device and/or obtaining a pre-defined threshold value by at least one of continuously measuring, detecting and recording by the sensor device. Any mobile communication device having the application program associated with the sensor device installed and activated and which is within short-range communication range to receive the at least one broadcast signal from the sensor device may then (be configured to) determine at least one of a distance to the sensor device by measurement by means of phase using a plurality of received short-range wireless broadcast signals and the signal strength of the at least one received short-range wireless broadcast signal and then send a message including data or information indicating the determined distance and/or signal strength of the short-range wireless broadcast signal to a communication node.

In embodiments, the sensor device comprises at least one of a temperature sensor, an accelerometer, a motion sensor, a gyro, a microphone, a potentiometer, a pressure sensor and a sensor for measuring the concentration of particles in media. In embodiments, the sensor device is configured to continuously measuring, detecting and recording at least one parameter related to at least one of temperature, pressure, luminance, particles in media, movement and acceleration where an obtained pre-defined threshold value is triggering the sensor device to send at least one broadcast signal or message, e.g. a sequence of broadcast signals. Any mobile communication device having the application program associated with the sensor device installed and activated and which is within short-range communication range to receive the at least one broadcast signal from the sensor device (which transmission is triggered by the obtaining of the pre-defined threshold value) may then (be configured to) determine at least one of a distance to the sensor device by measurement by means of phase using a plurality of received short-range wireless broadcast signals and the signal strength of the at least one received short-range wireless broadcast signal and then send a message including data or information indicating the determined distance and/or signal strength of the short-range wireless broadcast signal to a communication node.

In embodiments, the technology disclosed relates to a method in a system comprising a sensor device, a communication node and at least one mobile communication device, comprising:
a) activating an input means of the sensor device, e.g. by pressing a button of the sensor device and/or obtaining a pre-defined threshold value by at least one of continuously measuring, detecting and recording by the sensor device;
b) transmitting, in response to said activating or obtaining a predefined threshold value and by said sensor device, at least one short-range wireless broadcast signal;
c) receiving, by each mobile communication devices within short-range communication range with the sensor device, at least one short-range wireless broadcast signal from said sensor device;
d) determining, by each mobile communication devices within short-range communication range with the sensor device, at least one of a distance to the sensor device by measurement by means of phase using a plurality of received short-range wireless broadcast signals and the signal strength of at least one received short-range wireless broadcast signal;
e) sending, by each mobile communication devices within short-range communication range with the sensor device during/at the time interval for/of said transmission of said at least one short-range wireless broadcast signal, a message including data or information indicating the respective determined distance and/or signal strength of the short-range wireless broadcast signal;
f) receiving, at the communication node, a message from each of said mobile communication devices within short-range communication range with the sensor device during/at the time interval for/of said transmission of said at least one short-range wireless broadcast signal; and
g) determining, by said communication node and at least partly based on the received data or information indicating the respective determined distance and/or signal strength received from the mobile communication devices within short-range communication range, which mobile communication device among said mobile communication devices within short-range communication range with the sensor device, is closest to the sensor device.

In embodiments, the technology disclosed relates to a method in a system comprising a sensor device, a communication node and at least one mobile communication device, comprising:
a) activating an input means of the sensor device, e.g. by pressing a button of the sensor device and/or obtaining a pre-defined threshold value by at least one of continuously measuring, detecting and recording by the sensor device;
b) transmitting, in response to said activating or obtaining a predefined threshold value and by said sensor device, at least one short-range wireless broadcast signal;
c) receiving, by each mobile communication devices within short-range communication range with the sensor device, at least one short-range wireless broadcast signal from said sensor device;
d) determining, by each mobile communication devices within short-range communication range with the sensor device, at least one of a distance to the sensor device by measurement by means of phase using a plurality of received short-range wireless broadcast signals and the signal strength of at least one received short-range wireless broadcast signal;
e) sending, by each mobile communication devices within short-range communication range with the sensor device during/at the time interval for/of said transmission of said at least one short-range wireless broadcast signal, a message including data or information indicating the respective determined distance and/or signal strength of the short-range wireless broadcast signal;
f) receiving, at the communication node, a message from each of said mobile communication devices within short-range communication range with the sensor device during/at the time interval for/of said transmission of said at least one short-range wireless broadcast signal; and
g) determining, by said communication node and at least partly based on the received data or information indicating the respective determined distance and/or signal strength received from the mobile communication devices within short-range communication range, which mobile communication device among said mobile communication devices within short-range communication range with the sensor device, is closest to the sensor device
h) sending, by said communication node, a push message to the mobile communication device determined by the communication node to be closest.

In embodiments, the technology disclosed relates to a method in a system comprising a sensor device, a communication node and at least one mobile communication device, comprising:
a) activating an input means of the sensor device, e.g. by pressing a button of the sensor device and/or obtaining a pre-defined threshold value by at least one of continuously measuring, detecting and recording by the sensor device;
b) transmitting, in response to said activating or obtaining a predefined threshold value and by said sensor device, at least one short-range wireless broadcast signal;
c) receiving, by each mobile communication devices within short-range communication range with the sensor device, at least one short-range wireless broadcast signal from said sensor device;
d) determining, by each mobile communication devices within short-range communication range with the sensor device, at least one of a distance to the sensor device by measurement by means of phase using a plurality of received short-range wireless broadcast signals and the signal strength of at least one received short-range wireless broadcast signal;
e) sending, by each mobile communication devices within short-range communication range with the sensor device during/at the time interval for/of said transmission of said at least one short-range wireless broadcast signal, a message including data or information indicating the respective determined distance and/or signal strength of the short-range wireless broadcast signal;
f) receiving, at the communication node, a message from each of said mobile communication devices within short-range communication range with the sensor device during/at the time interval for/of said transmission of said at least one short-range wireless broadcast signal; and
g) determining, by said communication node and at least partly based on the received data or information indicating the respective determined distance and/or signal strength received from the mobile communication devices within short-range communication range, which mobile communication device among said mobile communication devices within short-range communication range with the sensor device, is closest to the sensor device; and
h) sending, from said communication node, a push message to the mobile communication device determined by the communication node to be closest, wherein said push message comprises content which is at least one of associated with said sensor device and associated with a product which is associated with said sensor device.

In embodiments, the technology disclosed relates to a method in a system comprising a sensor device, a communication node and at least one mobile communication device, comprising:
a) activating an input means of the sensor device, e.g. by pressing a button of the sensor device and/or obtaining a pre-defined threshold value by at least one of continuously measuring, detecting and recording by the sensor device;
b) transmitting, in response to said activating or obtaining a predefined threshold value and by said sensor device, at least one short-range wireless broadcast signal;
c) receiving, by each mobile communication devices within short-range communication range with the sensor device, at least one short-range wireless broadcast signal from said sensor device;
d) determining, by each mobile communication devices within short-range communication range with the sensor device, at least one of a distance to the sensor device by measurement by means of phase using a plurality of received short-range wireless broadcast signals and the signal strength of at least one received short-range wireless broadcast signal;
e) sending, by each mobile communication devices within short-range communication range with the sensor device during/at the time interval for/of said transmission of said at least one short-range wireless broadcast signal, a message including data or information indicating the respective determined distance and/or signal strength of the short-range wireless broadcast signal;
f) receiving, at the communication node, a message from each of said mobile communication devices within short-range communication range with the sensor device during/at the time interval for/of said transmission of said at least one short-range wireless broadcast signal; and
g) determining, by said communication node and at least partly based on the received data or information indicating the respective determined distance and/or signal strength received from the mobile communication devices within short-range communication range, which mobile communication device among said mobile communication devices within short-range communication range with the sensor device, is closest to the sensor device
h) sending, from said communication node, a connection request message to the mobile communication device determined by the communication node to be closest to the sensor device;
i) sending, from mobile communication device determined by the communication node to be closest to the sensor device, a request confirm message to the communication node; and
j) establishing a connection, e.g. a Bluetooth connection, between the communication node and the mobile communication device determined by the communication node to be closest to the sensor device.

In embodiments, the technology disclosed relates to a method in a system comprising a sensor device, a communication node and at least one mobile communication device, comprising:
a) activating an input means of the sensor device, e.g. by pressing a button of the sensor device and/or obtaining a pre-defined threshold value by at least one of continuously measuring, detecting and recording by the sensor device;
b) transmitting, in response to said activating or obtaining a predefined threshold value and by said sensor device, at least one short-range wireless broadcast signal;
c) receiving, by each mobile communication devices within short-range communication range with the sensor device, at least one short-range wireless broadcast signal from said sensor device;
d) determining, by each mobile communication devices within short-range communication range with the sensor device, at least one of a distance to the sensor device by measurement by means of phase using a plurality of received short-range wireless broadcast signals and the signal strength of at least one received short-range wireless broadcast signal;
e) sending, by each mobile communication devices within short-range communication range with the sensor device during/at the time interval for/of said transmission of said at least one short-range wireless broadcast signal, a message including data or information indicating the respective determined distance and/or signal strength of the short-range wireless broadcast signal;
f) receiving, at the communication node, a message from each of said mobile communication devices within short-range communication range with the sensor device during/at the time interval for/of said transmission of said at least one short-range wireless broadcast signal; and
g) determining, by said communication node and at least partly based on the received data or information indicating the respective determined distance and/or signal strength received from the mobile communication devices within short-range communication range, which mobile communication device among said mobile communication devices within short-range communication range with the sensor device, is closest to the sensor device
h) sending, from said communication node, a connection request message to the mobile communication device determined by the communication node to be closest to the sensor device;
i) sending, from mobile communication device determined by the communication node to be closest to the sensor device, a request confirm message to the communication node; and
j) establishing a temporary communication session, e.g. a temporary Bluetooth session, with the mobile communication device determined by the communication node to be closest to the sensor device.

In certain embodiments, the technology disclosed relates to a method for a system comprising a sensor device and at least one mobile communication device having an application program (APP) associated with the sensor device installed. The sensor device may be configured to broadcast a message and each of the at least one mobile communication device having an application program installed and activated/running are configured to send, in response to receiving at least one short-range wireless broadcast signal from the sensor device, a message including data or information indicating the respective determined distance and/or signal strength of the short-range wireless broadcast signal. Each application program that catches the broadcasted message may then be configured to send another message to the server instance including information indicating the respective determined distance and/or signal strength of the short-range wireless broadcast signal. In embodiments, the server may use an algorithm to determine which application program is closest in proximity to the sensor device.

In embodiments, the technology disclosed relates to a system comprising a sensor device, a communication node and at least one mobile communication device having an application program associated with said sensor device installed, said sensor device is configured to at least one of transmit one or a plurality of short-range wireless broadcast signals in response to the activating of an input means of the sensor device or the obtaining of a threshold value by a sensor of the sensor device, wherein each of the at least one mobile communication device having said application program associated with the sensor device activated and which is within short-range communication range with the sensor device during/at the time interval for/of the transmission of one or a plurality of short-range wireless broadcast signals from the sensor device, is configured to:
determine at least one of a distance to the sensor device by measurement by means of phase using a plurality of received short-range wireless broadcast signals and the signal strength of the received short-range wireless broadcast signal; and
send, to the communication node, a message containing data or information indicating the determined distance measured by means of phase and/or signal strength and at least one of the unique identification data of the respective mobile communication device, the unique identification data of a user associated with the respective mobile communication device and the unique application program identifier of the respective mobile communication device; and wherein the communication node is configured to:
receive a message from the respective of said at least one mobile communication device, and identify at least one of a unique application program identifier and the unique identity of the at least one mobile communication device, wherein the communication node is further configured to determine which mobile communication device is closest to the sensor device at least partly based on data or information received in a message from the respective at least one mobile communication devices providing an indication of the determined distance measured by means of phase and/or signal strength of a short-range wireless broadcast signal.

In embodiments, the technology disclosed relates to a method in a system comprising a sensor device, a communication node and at least one mobile communication device having an application program (APP) associated with the sensor device installed, comprising:
a) activating an input means of the sensor device, e.g. by pressing a button of the sensor device and/or obtaining a threshold value by at least one of continuously measuring, detecting and recording by a sensor of the sensor device;
b) transmitting, in response to said activating and/or obtaining a threshold value and by said sensor device, at least one short-range wireless broadcast signal;
c) receiving, by each mobile communication devices within short-range communication range with the sensor device, at least one short-range wireless broadcast signal from said sensor device;
d) determining, by each mobile communication devices within short-range communication range with the sensor device, at least one of a distance to the sensor device by measurement by means of phase using a plurality of received short-range wireless broadcast signals and the signal strength of at least one received short-range wireless broadcast signal;
e) sending, by each mobile communication devices having the application program (APP) associated with the sensor device installed and activated and which is within short-range communication range with the sensor device during/at the time interval for/of said transmission of said at least one short-range wireless broadcast signal, a message including data or information indicating the respective determined distance and/or signal strength of the short-range wireless broadcast signal;
f) receiving, by the communication node, a message from each of said mobile communication devices having the application program (APP) activated and which is within short-range communication range with the sensor device during/at the time interval for/of said transmission of said at least one short-range wireless broadcast signal; and
i) determining, by said communication node and at least partly based on the received data or information indicating the respective determined distance and/or signal strength received from each mobile communication devices having the application program (APP) activated and which is within short-range communication range, which mobile communication device among said within short-range communication range with the sensor device at the time of said transmission of said at least one short-range wireless broadcast signal, is closest to the sensor device

In embodiments, the technology disclosed relates to a method in a system comprising a sensor device, a communication node and at least one mobile communication device having an application program (APP) associated with the sensor device installed, comprising:
a) activating an input means of the sensor device, e.g. by pressing a button of the sensor device and/or obtaining a threshold value by at least one of continuously measuring, detecting and recording by a sensor of the sensor device;
b) transmitting, in response to said activating and/or obtaining a threshold value and by said sensor device, at least one short-range wireless broadcast signal;
c) receiving, by each mobile communication devices within short-range communication range with the sensor device, at least one short-range wireless broadcast signal from said sensor device;
d) determining, by each mobile communication devices within short-range communication range with the sensor device, at least one of a distance to the sensor device by measurement by means of phase using a plurality of received short-range wireless broadcast signals and the signal strength of at least one received short-range wireless broadcast signal;
e) sending, by each mobile communication devices having the application program (APP) associated with the sensor device installed and activated and which is within short-range communication range with the sensor device during/at the time interval for/of said transmission of said at least one short-range wireless broadcast signal, a message including data or information indicating the respective determined distance and/or signal strength of the short-range wireless broadcast signal;
f) receiving, by the communication node, a message from each of said mobile communication devices having the application program (APP) activated and which is within short-range communication range with the sensor device during/at the time interval for/of said transmission of said at least one short-range wireless broadcast signal;
g) determining, by said communication node and at least partly based on the received data or information indicating the respective determined distance and/or signal strength received from each mobile communication devices having the application program (APP) activated and which is within short-range communication range, which mobile communication device among said within short-range communication range with the sensor device at the time of said transmission of said at least one short-range wireless broadcast signal, is closest to the sensor device and
h) sending, from said communication node, a push message to the mobile communication device determined by the communication node to be closest, wherein said push message comprises content which is at least one of associated with said sensor device and associated with a product which is associated with said sensor device.

In embodiments, the technology disclosed relates to a mobile communication device having an application program (APP) associated with a sensor device installed, said mobile communication device is configured to:
a) activate said application program (APP) associated with the sensor device;
b) receive at least one short-range wireless broadcast signal from the sensor device when the mobile communication device is within short-range communication range with the sensor device;
c) determine at least one of a distance to the sensor device by measurement by means of phase using a plurality of received short-range wireless broadcast signals and the signal strength of at least one received short-range wireless broadcast signal; and
d) send a message including data or information indicating the determined distance and/or signal strength of the short-range wireless broadcast signal to a communication node; and
e) receive a push message from the communication node, wherein said push message is associated with said sensor device.

In embodiments, the technology disclosed relates to a mobile communication device having an application program (APP) associated with a sensor device installed, said mobile communication device is configured to:
a) activate said application program (APP) associated with the sensor device;
b) receive at least one short-range wireless broadcast signal from the sensor device when the mobile communication device is within short-range communication range with the sensor device;
c) determine at least one of a distance to the sensor device by measurement by means of phase using a plurality of received short-range wireless broadcast signals and the signal strength of at least one received short-range wireless broadcast signal; and
d) send a message including data or information indicating the determined distance and/or signal strength of the short-range wireless broadcast signal to a communication node;
e) receive a connection request from the communication node for establishing a connection with the communication node; and
f) send a request confirm message to the communication node.

In embodiments, the technology disclosed relates to a mobile communication device having an application program (APP) associated with a sensor device installed, said mobile communication device is configured to:
a) activate said application program (APP) associated with the sensor device;
b) receive at least one short-range wireless broadcast signal from the sensor device when the mobile communication device is within short-range communication range with the sensor device;
c) determine at least one of a distance to the sensor device by measurement by means of phase using a plurality of received short-range wireless broadcast signals and the signal strength of at least one received short-range wireless broadcast signal;
d) send a message including data or information indicating the determined distance and/or signal strength of the short-range wireless broadcast signal to a communication node;
e) receive a connection request from the communication node for establishing a temporary communication session with the communication node; and
f) send a request confirm message to the communication node.

In embodiments, the technology disclosed relates to methods, a sensor device, a communication node and a system for providing information and/or sending a message to a person who interacted with a sensor device, where the determining of which person is closest to the sensor device is at least partly based on at least one distance measurement by means of phase using at least two broadcast signals transmitted from the sensor device and received by a mobile communication device associated with a user or person. In these embodiments, the broadcast signals transmitted from the sensor device have different frequencies and the distance between at least one mobile communication device and the sensor device is determined by measurement by means of phase using the at least two broadcast signals transmitted by the sensor device.

In embodiments, the technology disclosed relates to a method in a system comprising a sensor device, a communication node and at least one mobile communication device, comprising:
a) transmitting, by said sensor device, at least one short-range wireless broadcast signal;
b) receiving, at one or more mobile communication devices, at least one short-range wireless broadcast signal from said sensor device;
c) determining, by each of said one or more mobile communication devices, at least one of a distance to the sensor device by measurement by means of phase using a plurality of received short-range wireless broadcast signal and the signal strength of at least one received short-range wireless broadcast signal;
d) sending, from each of said one or more mobile communication devices, a message including data or information indicating the respective determined distance and/or signal strength of the short-range wireless broadcast signal;
e) receiving, at the communication node, said message from the respective one or more mobile communication devices; and
f) determining, by said communication node and at least partly based on the received data or information indicating the respective determined distance and/or signal strength received from the one or more mobile communication devices, which mobile communication device is closest to the sensor device.

In embodiments, the technology disclosed relates to methods, a sensor device, a communication node and a system for providing a person with product-related information by determining which person is closest to the sensor device at least partly based on at least one distance measurement by means of phase of signals received by the mobile communication device of the person determined to be closest to the sensor device. The product-related information may then relate to a trademark, product or product category associated with, or logically connected to, the sensor device to which the person is determined to be closest to. In embodiments, the transmission of the broadcast signal received by the mobile communication device from the sensor device may have been triggered by the person closest to the sensor device activating an input means of the sensor device, e.g. by pressing a button of the sensor device.

In embodiments, the method further comprises transmitting a short-range wireless broadcast signal with a predefined wake-up message that the said mobile communication devices receives and upon receiving said wake-up message, temporarily changes parameters of said mobile communication devices that allows the communication devices to listen to short-range wireless broadcast signals from said sensor devices faster than before.

In embodiments, the technology disclosed relates to methods, a sensor device, a communication node and a system for alerting a person closest to the sensor device at least partly based on measuring the distance by means of phase of broadcast signals received by the mobile communication device of the person determined to be closest to the sensor device. The product-related information may then relate to a trademark, product or product category which is associated with, or logically connected to, the sensor device to which the person is determined to be closest to. In embodiments, the transmission of the broadcast signal received by the mobile communication device from the sensor device may have been triggered by the sensor device obtaining a pre-defined threshold value, e.g. by at least one of measuring, detecting or recording at least one parameter related to at least one of temperature, pressure, luminance, particles in medium, movement and acceleration.

In embodiments, the technology disclosed relates to a method in a system comprising a sensor device, a communication node and at least one mobile communication device, comprising:
a) transmitting, by said sensor device, at least two short-range wireless broadcast signals having different frequencies;
b) receiving, at one or more mobile communication devices, the at least two short-range wireless broadcast signals having different frequencies from said sensor device;
c) measuring, by each of said one or more mobile communication devices, the distance by means of phase using the at least two short-range wireless broadcast signals having different frequencies;
d) sending, from each of said one or more mobile communication devices, a message including data or information indicating the respective measured distances by means of phase;
e) receiving, at the communication node, said message from the respective one or more mobile communication devices; and
f) determining, by said communication node and at least partly based on the received data or information indicating the respective measured distance by means of phase, which mobile communication device is closest to the sensor device.

In embodiments, system comprising a sensor device, a communication node and at least one mobile communication device, each at least one mobile communication device comprising an application program, said sensor device is configured to at least one of transmit one or a plurality of short-range wireless broadcast signals, wherein each of the at least one mobile communication device is configured to receive a short-range wireless broadcast signal from said sensor device, and wherein
each of the one or more mobile communication devices is further configured to determine at least one of a distance to the sensor device by measurement by means of phase using a plurality of received short-range wireless broadcast signals and the signal strength of the received short-range wireless broadcast signal and further to send, to said communication node, a message containing data or information indicating the determined distance measured by means of phase and/or signal strength and at least one of the unique identification data of the respective mobile communication device, the unique identification data of a user associated with the respective mobile communication device and the unique application program identifier of the respective mobile communication device;
the communication node is configured to receive a message from the respective one or more mobile communication devices and identify at least one of a unique application program identifier and the unique identity of the respective one or more mobile communication device, wherein the communication node is further configured to determine which mobile communication device is closest to the sensor device at least partly based on data or information received in a message from the respective one or more mobile communication devices providing an indication of the determined distance measured by means of phase and/or signal strength of a short-range wireless broadcast signal.

In certain embodiments, the communication node, e.g. server instance, of the system is further configured to determine which mobile communication device is closest to the sensor device at least partly based on data or information in a message received from a mobile communication device is indicating that the signal strength determined by a mobile communication device exceeds a pre-defined signal strength threshold value and/or that a distance to the sensor device measured by means of phase is shorter than a pre-defined distance threshold value.

In embodiments, the at least one short-range wireless broadcast signal in the above-mentioned method includes data or information indicating at least one of sensor device category data and the unique identification data of said sensor device.

In embodiments, the message sent from each of said one or more mobile communication devices in the above-mentioned method further includes data or information indicating at least one of the identity of the respective mobile communication device, an application program identifier of the respective mobile communication device, user login identification data associated with the user of the application program of the respective mobile communication device, the device category of said sensor device and the unique identification data of said sensor device.

In embodiments, the above-mentioned method further comprises the action of activating an input means of said sensor device, wherein said at least one short-range wireless broadcast signal is transmitted by said sensor device in response to said input device being activated.

In embodiments, the above-mentioned method further comprises the steps of continuously measuring, detecting and/or recording, by the sensor device, at least one of temperature, pressure, luminance, particles in medium, movement and acceleration, and obtaining a pre-defined threshold value by said continuously measuring, detecting and/or recording, wherein said at least one short-range wireless broadcast signal is transmitted by said sensor device in response to obtaining said pre-defined threshold value.

In certain embodiments, the method according to any of the above-mentioned embodiments further comprises determining by said communication node which mobile communication device is closest to the sensor device is at least partly based on the communication node performing the step of comparing data or information indicating a determined signal strength of a short-range wireless broadcast signal in a message received from a first mobile communication device with data or information indicating a determined signal strength of a short-range wireless broadcast signal in at least one other message received by said communication node from at least one other second mobile communication device.

In certain embodiments, the method according to any of the above-mentioned embodiments further comprises the step of determining, by the communication node, which mobile communication device is closest to the sensor device comprises determining, which mobile communication device is closest to the sensor device at least partly based on data or information in a message received from a mobile communication device is indicating that the signal strength determined by a mobile communication device exceeds a pre-defined signal strength threshold value.

In certain embodiments, the method according to any of the above-mentioned embodiments further comprises receiving, by a plurality of mobile communication devices, a short-range wireless broadcast signal from the sensor device, the method further comprising:
sending, from each of said plurality of mobile communication devices, a message including data or information indicating a determined signal strength of a short-range wireless broadcast signal; and
receiving, at said communication node, a message from respective of said plurality of mobile communication devices including data or information indicating the signal strength of a short-range wireless broadcast signal determined by the respective mobile communication device; and
determining, by said communication node, which mobile communication device among said plurality of mobile communication device is closest to the sensor device at least partly based on signal strength, wherein said determining is at least partly based on comparing data or information indicating a determined signal strength of a short-range wireless broadcast signal in a message received from a first mobile communication device with data or information indicating a determined signal strength of a short-range wireless broadcast signal in at least one other message received by said communication node from at least one other second mobile communication device.

In certain embodiments, the method according to any of the above-mentioned embodiments further comprises at least one of:
sending, from said communication node, a push message to the mobile communication device determined by the communication node to be the closest mobile communication device to the sensor device;
establishing a connection or temporary communication session between said communication node and the mobile communication device determined by the communication node to be the closest mobile communication device to the sensor device, wherein said establishing of said connection or temporary communication session is initiated by said communication node sending a wireless connection request to said mobile communication device;
extending the period of a timer for an already established connection or temporary communication session between said communication node and the mobile communication device determined by the communication node to be the closest mobile communication device to the sensor device, wherein said connection or temporary communication session was established in connection with sending said message from the mobile communication device to the communication node;
executing, by said communication node, a set of instructions associated with the mobile communication device, or a user associated with the mobile communication device, determined by the communication node to be the closest mobile communication device to the sensor device; and
sending, from said communication node, a token or message to another communication node, wherein said message or token contains a set of instructions or data triggering the other communication node to perform further processing operations associated with the mobile communication device, or a user associated with the mobile communication device, determined by the communication node to be the closest mobile communication device to the sensor device.

In embodiments, the technology disclosed relates to a communication node configured to receive a message from one or more mobile communication devices in a system comprising a sensor device, wherein the communication node is further configured to:
determine which mobile communication device is closest to the sensor device at least partly based on data or information received in a message from one or more mobile communication devices providing an indication of a determined signal strength of a short-range wireless broadcast signal received by the respective one or more mobile communication devices from said sensor device.

In embodiments, the communication node of the technology disclosed is further configured to determine which mobile communication device is closest to the sensor device by comparing data or information indicating a determined signal strength of a short-range wireless broadcast signal in a message received from a first mobile communication device with data or information indicating a determined signal strength of a short-range wireless broadcast signal in at least one other message received by the communication node from at least one other second mobile communication device.

In embodiments, the communication node of the technology disclosed is configured to determine which mobile communication device is closest to the sensor device at least partly based on data or information in a message received from a mobile communication device is indicating that the signal strength determined by a mobile communication device exceed a pre-defined signal strength threshold value.

In embodiments, the communication node of the technology disclosed is further configured to perform at least one of the following actions in response to said determining of which mobile communication device is closest to said sensor device:
sending, from said communication node, a push message to the mobile communication device determined by the communication node to be the closest mobile communication device to the sensor device;
establishing a connection or temporary communication session between said communication node and the mobile communication device determined by the communication node to be the closest mobile communication device to the sensor device, wherein said establishing of said connection or temporary communication session is initiated by said communication node sending a wireless connection request to said mobile communication device;
extending the period of a timer for an already established connection or temporary communication session between said communication node and the mobile communication device determined by the communication node to be the closest mobile communication device to the sensor device, wherein said connection or temporary communication session was established in connection with sending said message from the mobile communication device to the communication node;
executing, by said communication node, a set of instructions associated with the mobile communication device, or a user associated with the mobile communication device, determined by the communication node to be the closest mobile communication device to the sensor device; and
sending, from said communication node, a token or message to another communication node, wherein said message or token contains a set of instructions or data triggering the other communication node to perform further processing operations associated with the mobile communication device, or a user associated with the mobile communication device, determined by the communication node to be the closest mobile communication device to the sensor device.

In embodiments, the communication node of the technology disclosed is a stationary unit in the form of a server, a gateway or a hub.

In embodiments, the communication node of the technology disclosed is communicatively coupled to, or associated with, a database configured to store information about at least one of the unique identities of sensor devices, the unique identities of mobile communication devices and the unique identities of users associated with the identities of the mobile communications devices.

In embodiments, the technology disclosed relates to a system comprising a sensor device, a communication node and at least one mobile communication device, each at least one mobile communication device comprising an application program, said sensor device is configured to at least one of transmit one or a plurality of short-range wireless broadcast signals, wherein each of the at least one mobile communication device is configured to receive a short-range wireless broadcast signal from said sensor device, and wherein each of the one or more mobile communication devices is further configured to determine the distance by means of measurement by means of phase and/or the signal strength of the received short-range wireless broadcast signal and further to send, to said communication node, a message containing data or information indicating the determined signal strength and at least one of the unique identification data of the respective mobile communication device, the unique identification data of a user associated with the respective mobile communication device and the unique application program identifier of the respective mobile communication device.

In certain embodiments, the technology disclosed relates to a system, comprising a sensor device, a server instance and one or more mobile communication device comprising an application program (APP). The sensor device may be configured to broadcast a message and the respective application program of the one or more mobile communication devices catches the broadcasted message. Each application program that catches the broadcasted message may then be configured to send another message to the server instance including information about the broadcasted message and the determined, by the application program/smartphone, distance by means of measurement by means of phase and/or the signal strength of the received broadcasted message. An algorithm used by the server instance may be configured to use the information sent from all mobile communication devices/application programs to determine which application program is closest in proximity to the sensor device. The server instance may then be configured to send a message to the application program that the algorithm determined to be closest in proximity to the sensor device.

In certain embodiments, a unique identifier of the sensor device is part of the information that is broadcasted by the sensor device. The application programs may then be configured to forward this unique identifier of the sensor device to the server instance, e.g. a button of the sensor device has a unique ID which is passed to a server.

In certain embodiments, the server instance is configured to use the unique identifier to look up information and/or a message in a database and thereafter send this information or message to the application program that the server instance algorithm determined to be closest in proximity to the sensor device. In certain embodiments, broadcast message includes an instruction or an address that the application programs use to understand which server instance to send its message to. As example and depending on which button (unique ID) is pressed, different messages may be sent to the person that pushed the button. In embodiments, there may be instructions in the button itself that determines which gateway, hub or server to connect to.

In embodiments, the application program that receives the message from the server instance is configured to send a message to the sensor device. In certain embodiments, the sensor device is configured too stop transmitting broadcast signals (advertising) when this message from the closest application program is received.

In embodiments, the server instance is configured to, upon receiving a message from an application program that indicates that the perceived signal strength from the sensor device's broadcast message is over a certain threshold, send a message to that application program immediately without waiting for more application program messages.

In embodiments, the communication node of the system according to the technology disclosed is configured to receive a message from the respective one or more mobile communication devices and identify at least one of a unique application program identifier and the unique identity of the respective one or more mobile communication device, wherein the communication node is further configured to determine which mobile communication device is closest to the sensor device at least partly based on data or information received in a message from the respective one or more mobile communication devices providing an indication of the determined signal strength of a short-range wireless broadcast signal.

In embodiments, the communication node may comprise software and/or an algorithm configured for determining which mobile communication device is closest to the sensor device. The software and/or algorithm may then use the information received from the respective at least one mobile communication device to determine which mobile communication is closest in proximity to the sensor device. The determination of which mobile communication is closest to the sensor device may then be at least partly based on data or information providing an indication of the determined signal strength of the short-range wireless broadcast signal received from the sensor device by the respective at least one mobile communication device.

In embodiments, the communication node of the system is further configured to determine which mobile communication device is closest to the sensor device by comparing data or information indicating a determined signal strength of a short-range wireless broadcast signal in a message received from a first mobile communication device with data or information indicating a determined signal strength of a short-range wireless broadcast signal in at least one other message received by the communication node from at least one other second mobile communication device.

In embodiments, the communication node of the system is further configured to determine which mobile communication device is closest to the sensor device at least partly based on data or information in a message received from a mobile communication device is indicating that the signal strength determined by a mobile communication device exceeds a pre-defined signal strength threshold value.

In embodiments, the communication node of the system is further configured to perform at least one of the following actions in response to said determining of which mobile communication device is closest to said sensor device:
sending, from said communication node, a push message to the mobile communication device determined by the communication node to be the closest mobile communication device to the sensor device;
establishing a connection or temporary communication session between said communication node and the mobile communication device determined by the communication node to be the closest mobile communication device to the sensor device, wherein said establishing of said connection or temporary communication session is initiated by said communication node sending a wireless connection request to said mobile communication device;
extending the period of a timer for an already established connection or temporary communication session between said communication node and the mobile communication device determined by the communication node to be the closest mobile communication device to the sensor device, wherein said connection or temporary communication session was established in connection with sending said message from the mobile communication device to the communication node;
executing, by said communication node, a set of instructions associated with the mobile communication device, or a user associated with the mobile communication device, determined by the communication node to be the closest mobile communication device to the sensor device; and
sending, from said communication node, a token or message to another communication node, wherein said message or token contains a set of instructions or data triggering the other communication node to perform further processing operations associated with the mobile communication device, or a user associated with the mobile communication device, determined by the communication node to be the closest mobile communication device to the sensor device.

In embodiments, the sensor device of the system according to the technology disclosed comprises input means, and wherein said sensor device is further configured so that said at least one short-range wireless broadcast signal is transmitted by said sensor device in response to said input device being activated.

In embodiments, the sensor device of the system according to the technology disclosed comprises means for continuously measuring, detecting and/or recording at least one of temperature, pressure, luminance, particles in medium, movement and acceleration; and wherein said at least one short-range wireless broadcast signal is transmitted by said sensor device in response to obtaining a pre-defined threshold value.

In certain embodiments, the technology disclosed relates to a method in a system comprising a sensor device, a communication node and at least one mobile communication device, comprising:
a) transmitting, by said sensor device, at least one short-range wireless broadcast signal in sequence, wherein said at least one short-range wireless broadcast signal includes data or information indicating at least one of sensor device category and unique identity of said sensor device;
b) receiving, at one or more mobile communication devices, a short-range wireless broadcast signal from said sensor device;
c) determining, by each of said one or more mobile communication devices, the signal strength of said short-range wireless broadcast signal received from said sensor device;
d) determining, by each of said one or more mobile communication devices and based on said data or information in said short-range wireless broadcast signal received from said sensor device, at least one of the sensor device category and unique identity of the sensor device transmitting said short-range wireless broadcast signal;
e) sending, from each of said one or more mobile communication devices, a response message to said sensor device, each response message including data or information indicating the respective determined signal strength and at least one of unique identity of the mobile communication device, unique identification data of an application program of the respective mobile communication device, the category of the sensor device and the unique identity of said sensor device; and
f) receiving, at said sensor device, a response message from the respective of the one or more mobile communication devices, each message including data or information indicating the signal strength of a short-range wireless broadcast signal determined by the respective mobile communication device.

In certain embodiments, the method according to the technology disclosed further comprises:
sending, from said sensor device to a communication node, a message including data or information indicating at least one of a determined signal strength of a short-range wireless broadcast signal exceeds a pre-defined signal strength threshold value and determined signal strengths of short-range wireless broadcast signals determined by respective of a plurality of mobile communication devices.

In certain embodiments, the method according to the technology disclosed further comprises:
determining, by said communication node, which mobile communication device is closest to the sensor device at least partly based on data or information in a message received from a mobile communication device is indicating that the signal strength determined by the mobile communication device exceeds a pre-defined signal strength threshold value and/or by comparing a plurality of determined signal strengths determined by respective of a plurality of mobile communication devices.

In certain embodiments, the method according to the technology disclosed further comprises:
determining, by said sensor device, which mobile communication device is closest to the sensor device at least partly based on data or information in a message received from a mobile communication device is indicating that the signal strength determined by the mobile communication device exceeds a pre-defined signal strength threshold value and/or by comparing signal strengths determined by respective of a plurality of mobile communication devices.

In embodiments, the above-mentioned sensor device may comprise software and/or an algorithm configured for determining which mobile communication device is closest to the sensor device. The software and/or algorithm may then use the information received in the response message from the respective at least one mobile communication device to determine which mobile communication is closest in proximity to the sensor device. The determination of which mobile communication is closest to the sensor device may then be at least partly based on data or information providing an indication of the determined signal strength of the short-range wireless broadcast signal received from the sensor device by the respective at least one mobile communication device.

In certain embodiments, the method according to the technology disclosed and in response to the sensor device determining which mobile communication device is closest to the sensor device, further comprises at least one of the following actions:
sending, from said sensor device, a push message to the mobile communication device determined by the sensor device to be the closest mobile communication device to the sensor device;
establishing a connection or temporary communication session between said sensor device and the mobile communication device determined by the sensor device to be the closest mobile communication device to the sensor device, wherein said establishing of said connection or temporary communication session is initiated by said sensor device sending a wireless connection request to said mobile communication device;
extending the period of a timer for an already established connection or temporary communication session between said sensor device and the mobile communication device determined by the sensor device to be the closest mobile communication device to the sensor device, wherein said connection or temporary communication session was established in connection with sending said response message from the mobile communication device to the sensor device;
executing, by said sensor device, a set of instructions associated with the mobile communication device, or a user associated with the mobile communication device, determined by the sensor device to be the closest mobile communication device to the sensor device; and
sending, from said sensor device, a token or message to a communication node or server instance, wherein said message or token contains a set of instructions or data triggering the communication node or server instance to perform further processing operations associated with the mobile communication device, or a user associated with the mobile communication device, determined by the server device to be the closest mobile communication device to the sensor device.

In certain embodiments, the technology disclosed relates to a sensor device configured to transmit at least one short-range wireless broadcast message in sequence, each short-range wireless broadcast message including at least one of sensor device category and the unique identity of the sensor device, wherein the sensor device is further configured to:
receive a response message from one or more mobile communication devices, the response message including data or information indicating a signal strength of a short-range wireless broadcast signal determined by respective mobile communication device and at least one of unique identification data of the respective mobile communication device and unique identification data of an application program of the respective mobile communication device, and wherein said sensor device is further configured to:
sending at least one message to a communication node in the form of a stationary gateway, server or hub, said at least one message including data or information indicating the respective determined signal strength in the response message received from respective mobile communication device and at least one of unique identification data of the respective mobile communication device and unique identification data of an application program of the respective mobile communication device.

In certain embodiments, the sensor device according to the technology disclosed comprises input means. The sensor device may then be further configured to, in response to activation of the input means, transmit at least one short-range wireless broadcast signal in sequence.

In certain embodiments, the sensor device according to the technology disclosed comprises input means in the form of a push button, a switch, a potentiometer, a temperature sensor, a motion sensor, an accelerometer, a gyro, a microphone and a pressure sensor.

In certain embodiments, the sensor device according to the technology disclosed comprises means for continuously measuring, detecting and/or recording, by the sensor device, at least one of temperature, pressure, luminance, particles in medium, movement and acceleration, and wherein said sensor device is further configured, in response to obtaining a pre-defined threshold value by said continuously measuring, detecting and/or recording, transmit said at least one short-range wireless broadcast signal in sequence.

In certain embodiments, the sensor device according to the technology disclosed comprises a timer. The sensor device may then be configured to set the timer in response to at least one of activation of an input means and obtaining a pre-defined threshold value by continuously measuring, detecting and/or recording. The sensor device may be further configured to stop sending out short-range wireless broadcast messages in response to expiration of the timer period.

In certain embodiments, the technology disclosed relates to a sensor device configured to transmit at least one short-range wireless broadcast message in sequence, each short-range wireless broadcast message including at least one of sensor device category and the unique identity of the sensor device, and, upon receiving a response message from one or more mobile communication devices and at least partly based on data or information in said at least one response message indicating the, by the respective mobile communication device, determined signal strength, determine that a certain mobile communication device is the closest to the sensor device.

In certain embodiments, the sensor device according to the technology disclosed is further configured to perform at least one of:
sending, from said sensor device, a push message to the mobile communication device determined by the communication node to be the closest mobile communication device to the sensor device;
establishing a connection between said sensor device and the mobile communication device determined by the sensor device to be the closest mobile communication device to the sensor device, wherein said establishing of said connection is initiated by said sensor device sending a wireless connection request to said mobile communication device; and
executing, by said sensor device, a set of instructions associated with the mobile communication device determined by the sensor device to be the closest mobile communication device to the sensor device.

In certain embodiments, the technology disclosed relates to a system comprising a sensor device, a communication node and at least one mobile communication device, each at least one mobile communication device comprising an application program, said sensor device is configured to send at least one short-range wireless broadcast message in sequence including at least one of sensor device category and the unique identity of the sensor device, wherein
a) each of the at least one mobile communication device is configured to receive a short-range wireless broadcast message from said sensor device and determine the signal strength of the short-range wireless broadcast message, wherein each of the at least one mobile communication device is further configured to send a message containing data or information indicating the determined signal strength to said communication node;
b) the sensor device is configured to, upon receiving a response message from one or more mobile communication devices and at least partly based on data or information in said at least one response message indicating a determined signal strength, determine that a certain mobile communication device is the closest to the sensor device, wherein said sensor device is further configured to send a message to the communication node containing at least one of application program identifier and unique identity of said one mobile communication device determined by the sensor device to be closest to the sensor device; and
c) the communication node is configured to receive said message from said sensor device and identify at least one of the application program identifier and the unique identity of the mobile communication device determined by the sensor device to be closest and, in response to receiving said message from the sensor device, perform at least one of:
   sending, from said communication node, a push message to the mobile communication device determined by the communication node to be the closest mobile communication device to the sensor device;
   establishing a connection or temporary communication session between said communication node and the mobile communication device determined by the communication node to be the closest mobile communication device to the sensor device, wherein said establishing of said connection or temporary communication session is initiated by said communication node sending a wireless connection request to said mobile communication device;
   extending the period of a timer for an already established connection or temporary communication session between said communication node and the mobile communication device determined by the communication node to be the closest mobile communication device to the sensor device, wherein said connection or temporary communication session was established in connection with sending said message from the mobile communication device to the communication node;
   executing, by said communication node, a set of instructions associated with the mobile communication device, or a user associated with the mobile communication device, determined by the communication node to be the closest mobile communication device to the sensor device; and
   sending, from said communication node, a token or message to another communication node, wherein said message or token contains a set of instructions or data triggering the other communication node to perform further processing operations associated with the mobile communication device, or a user associated with the mobile communication device, determined by the communication node to be the closest mobile communication device to the sensor device.

In certain embodiments, the technology disclosed relates to a system comprising a sensor device, an application program (APP) of a smartphone and a communication node such as a gateway, server or hub. The sensor device may be configured to transmit a broadcast message/signal which the application program (APP)/smartphone receives and respond to by sending a response message containing a value that is calculated by an algorithm of the smartphone. The algorithm may take the signal strength of the sensor device's broadcast message which the application program/smartphone perceived as an input. The sensor device may then be configured to, upon receiving a response message from one or more mobile communication device and their respective application programs, compare the value in each response message and then send a message to the communication node, where the response message contains the application program identifier of the application program that had the highest signal strength value in its response. The communication node may then be configured to, upon receiving the message from the sensor device, perform at least one of executing a set of instructions associated with the user of the application program/smartphone determined to be closest to the sensor device, establishing a connection with the user of the application program/smartphone, and/or sending, to another communication node, instructions associated with the user of the application program/smartphone determined to be closest to the sensor device.

In certain embodiments, the technology disclosed relates to a sensor device configured to broadcast a message and then listen to responses from receiving units, e.g. mobile communication devices. Each of the responses may then include a number that relates to factors including the signal strength of the broadcast message that the receiving unit perceived. The sensor device may then be configured to, at least partly based on these received numbers, determine which of the receiving units that is closest to the sensor device and then send a message only to that receiving unit.

### BRIEF DESCRIPTION OF DRAWINGS

FIG. 1 illustrates a system and methods according to embodiments of the technology disclosed.

FIG. 2 illustrates a system and methods according to embodiments of the technology disclosed.

FIG. 3 illustrates a system and methods according to embodiments of the technology disclosed.

### DETAILED DESCRIPTION

In the drawings, similar details are denoted with the same reference number throughout the different embodiments.

It is to be understood that the aspects and embodiments of the present disclosure described above may be used in any combination with each other. Several of the aspects and embodiments may be combined together to form a further embodiment of the present disclosure. A system, a method, a sensor device, or a communication node which is an aspect of the present disclosure may comprise at least one of the embodiments of the present disclosure described above.

A sensor device is herein defined as a device comprising at least one of an input means (e.g. a button), a temperature sensor, an accelerometer, a motion sensor, a gyro, a microphone, a potentiometer, a pressure sensor and a sensor for measuring the concentration of particles in media. The sensor device according to the technology disclosed comprises input means such as a touch-sensitive button and/or may be configured to at least one of measuring, detecting or recording at least one parameter related to at least one of temperature, pressure, luminance, particles in medium, movement and acceleration.

In wireless communications, particularly in radio frequency, signal strength (also referred to as field strength) refers to the transmitter power output as received by a reference antenna at a distance from the transmitting antenna. High-powered transmissions, such as those used in broadcasting, are expressed in dB-millivolts per metre (dBmV/m). For very low-power systems, such as mobile phones, signal strength is usually expressed in dB-microvolts per metre (dBμV/m) or in decibels above a reference level of one milliwatt (dBm). In broadcasting terminology, 1 mV/m is 1000 μV/m or 60 dBμ. (often written dBu).

In embodiments of the technology disclosed, distance measurements by means of phase which are performed by the mobile communication devices are used for determining which mobile communication device is closest to the sensor device.

In certain embodiments, a distance measurement by means of phase is used in a scheme to locate a transmitter. The system typically consists of three antennas. There is a transmitter in the sensor device, that in a sense acts as a target, in terms of radar concepts. Two receivers in the mobile communication device are used to determine the distance needed to find the position of the transmitter, i.e. the position of the sensor device.

A simpler way to measure distance according to certain embodiments of the technology disclosed is to calculate the phase shift between the received signal and the transmitted signal. The set-up considered here is not a typical radar since the target is replaced by a transmitter. In wave motion, the phase increases in the direction of propagation. Phase shifts are often measured in degrees. Frequency and phase evaluation results are combined to reach the aspired accuracy in the m range. Consequently, after the coarse detection using the frequency a correction of the estimated position is accomplished by the evaluated phase information within the unambiguous range. The important entity is the phase difference between the reference and the received wave/signal. In certain embodiments, the phase method may to some degree be combined with a Frequency-Modulated Continuous Wave (FMCW) measurement.

FMCW radar (Frequency-Modulated Continuous Wave radar=FMCW radar) is a special type of radar sensor which radiates continuous transmission power like a simple continuous wave radar (CW-Radar). In contrast to this CW radar FMCW radar can change its operating frequency during the measurement: that is, the transmission signal is modulated in frequency (or in phase). Possibilities of Radar measurements through runtime measurements are only technically possible with these changes in the frequency (or phase).

Simple continuous wave radar devices without frequency modulation have the disadvantage that it cannot determine target range because it lacks the timing mark necessary to allow the system to time accurately the transmit and receive cycle and to convert this into range. Such a time reference for measuring the distance of stationary objects but can be generated using of frequency modulation of the transmitted signal. In this method, a signal is transmitted, which increases or decreases in the frequency periodically. When an echo signal is received, that change of frequency gets a delay Δt (by runtime shift) like to as the pulse radar technique. In pulse radar, however, the runtime must be measured directly. In FMCW radar are measured the differences in phase or frequency between the actually transmitted and the received signal instead.

The basic features of FMCW radar are:
Ability to measure very small ranges to the target (the minimal measured range is comparable to the transmitted wavelength);
Ability to measure simultaneously the target range and its relative velocity;
Very high accuracy of range measurement;
Signal processing after mixing is performed at a low frequency range, considerably simplifying the realization of the processing circuits;
Safety from the absence of the pulse radiation with a high peak power.

Characteristics of FMCW radar are:
The distance measurement is accomplished by comparing the frequency of the received signal to a reference (usually directly the transmission signal).
The duration of the transmitted waveform T is substantially greater than the required receiving time for the installed distance measuring range.

In embodiments of the technology disclosed using distance measurements by means of phase to determine which mobile communication device is closest to the sensor device, the hardware typically consists of three antennas, one for transmission and two for the reception. A transmitting antenna can be viewed as a device that converts a guided electromagnetic wave on a transmission line into a spherical wave propagation in free space. In certain embodiments, the reception antennas may be controlled with a relay since two measurements are needed. The distances between the reception antennas and the transmitting antenna are measured.

The technology disclosed relates to methods, a sensor device, a communication node and a system for providing a person with information by determining which person is closest to the sensor device at least partly based on at least one of the determined signal strength and a distance measurements by means of phase of at least one broadcast signal received by the mobile communication device of the person or user determined to be closest to the sensor device.

In aspects, the technology disclosed relates to methods, a sensor device, a communication node and a system for determining which mobile communication device, and associated user, is currently closest to a sensor device at least partly based on at least one of a determined signal strength and a distance measurements by means of phase of at least one broadcast signal sent from the sensor device and which is received by at least one mobile communication device.

In other aspects, the technology disclosed relates to methods, a sensor device, a communication node and a system for determining which user activated an input means of a sensor device at least partly based on a determined signal strength of a broadcast signal sent from the sensor device and which is received by at least one mobile communication device, including the mobile communication device of the user who activated the input device.

In certain aspects, the technology disclosed relates to methods, a sensor device, a communication node and a system for determining which user activated an input means of a sensor device at least partly based on a determined signal strength value of at least one broadcast signal sent from the sensor device, wherein the at least one broadcast signal is sent from the sensor device in response to the activating of the input means and the signal strength value is determined by at least one mobile communication device, and wherein the at least one mobile communication device includes the mobile communication device of the user who activated the input device.

In certain aspects, the technology disclosed relates to methods, a sensor device, a communication node and a system for alerting a user of a mobile communication device determined to be closest to the sensor device, at least partly based on determining a signal strength of a broadcast signal sent from the sensor device, that the sensor device has obtained a pre-defined threshold value by at least one of continuously measuring, detecting and recording.

In certain aspects, the technology disclosed relates to methods, a sensor device, a communication node and a system configured to allow for a simple way to obtain information associated with a sensor device, and/or provide information to the user of a mobile communication device determined to be closest to the sensor device in response to obtaining a threshold value by the sensor device.

According to aspects, the technology disclosed relates to methods, a sensor device, a communication node and a system for determining which mobile communication device and associated user is closest to a sensor device in a system comprising a sensor device, a communication node and at least one mobile communication device, wherein at least one broadcast signal is sent from the sensor device in response to at least one of the activation of an input means of the sensor device and a pre-defined threshold value is obtained by the sensor device, wherein the signal strength of the at least one broadcast signal is determined by at least one mobile communication device receiving the at least one broadcast signal. The determination of which mobile communication device is closest to the sensor device is at least partly based on the determined signal strength of the at least one broadcast signal and the at least one mobile communication device includes the mobile communication device determined to be closest to the sensor device.

According to certain aspects of the technology disclosed, a broadcast signal, or a sequence of broadcast signals, is transmitted from a sensor device, via short-range wireless communication in response to a trigger event sensed by the sensor device. The broadcast signal may then include a unique identifier of the sensor device and the trigger event may be any of activating an input means of the sensor device, e.g. pushing a button of the sensor device by a person, or that a sensor or detector of the sensor device obtaining a pre-defined threshold value by at least one of continuously measuring, detecting and recording.

In embodiments, the technology disclosed relates to methods, a sensor device, a communication node and a system allowing for a person activating an input means of a sensor device to obtain information associated with the sensor device, e.g. obtain information related to a certain product, trademark and/or category of products associated with the sensor device.

In embodiments, the technology disclosed relates to methods, a sensor device, a communication node and a system for providing information to the user of a mobile communication device in response to obtaining a pre-defined threshold value, where the pre-defined threshold value is at least one of determined, measured, detected or recorded by the sensor device.

In certain aspects, the technology disclosed describes a system comprises a sensor device that is configured to send at least one short-range wireless broadcast signal, e.g. over a wireless communication network, in response to the sensor device obtaining a pre-defined threshold value or in response to a trigger event sensed by a sensor comprised in the sensor device. The at least one short-range wireless broadcast signal, or message, consists of a unique identifier of the sensor device.

The system may further comprise at least one mobile communication device configured to determine the signal strength of a short-range wireless broadcast signal received from the sensor device and to send a message to a communication node, e.g. server, gateway or hub, where the message includes the unique identity of the respective mobile communication device and data or information indicating the respective determined signal strength of the received short-range wireless broadcast signal.

In embodiments, the communication node, e.g. server, gateway or hub, may be configured to receive the message including the determined signal strength and the identity of the respective mobile communication device and compare the signal strength values received from a plurality of mobile communication devices to determine, at least partly based on these signal strength values, which of the plurality of mobile communication device is closest to the sensor device.

In embodiments, the communication node, e.g. server, gateway or hub, may be configured to to determine that the signal strength value received from a mobile communication device exceeds a pre-defined signal strength threshold value and, at least partly based on this, determine that this particular mobile communication device is the closest mobile communication device to the sensor device.

In embodiments, the technology disclosed relates to methods, a sensor device, a communication node and a system for providing information and/or sending a message to a person who interacted with a sensor device, where the determining of which person is closest to the sensor device is at least partly based on a determined signal strength of a signal transmitted from the sensor device and received by a mobile communication device associated with a person. In embodiments, the technology disclosed relates to methods, a sensor device, a communication node and a system for providing a person with product-related information by determining which person is closest to the sensor device at least partly based on the determined signal strength of a broadcast signal received by the mobile communication device of the person determined to be closest to the sensor device. The product-related information may then relate to a trademark, product or product category associated with, or logically connected to, the sensor device to which the person is determined to be closest to. In embodiments, the transmission of the broadcast signal received by the mobile communication device from the sensor device may have been triggered by the person closest to the sensor device activating an input means of the sensor device, e.g. by pushing a button of the sensor device.

In embodiments, the technology disclosed relates to methods, a sensor device, a communication node and a system for alerting a person closest to the sensor device at least partly based on determining the signal strength of a broadcast signal received by the mobile communication device of the person determined to be closest to the sensor device. The product-related information may then relate to a trademark, product or product category which is associated with, or logically connected to, the sensor device to which the person is determined to be closest to. In embodiments, the transmission of the broadcast signal received by the mobile communication device from the sensor device may have been triggered by the sensor device obtaining a pre-defined threshold value, e.g. by at least one of measuring, detecting or recording at least one parameter related to at least one of temperature, pressure, luminance, particles in medium, movement and acceleration.

In embodiments, the communication node may be further configured to, in response to determining the closest mobile communication device to the sensor device, execute or send a set of instructions associated with the mobile communication device determined to be closest to the sensor device and/or send, or send instructions for the transmission of, a message to the mobile communication device determined to be closest to the sensor device, e.g. a push message. In embodiments, the set of instructions associated with the mobile communication device determined to be closest to the sensor device may be sent to another second communication node, e.g. a server, which is in turn is configured to send, or send instructions for the transmission of, a message to the mobile communication device determined, by the first communication node, to be closest to the sensor device.

In embodiments, the communication node may be configured to, in response to determining the closest mobile communication device to the sensor device, access a pre-configured action profile associated with the unique identifier of the mobile communication device in the received message and cause a response action to be executed based on information in the accessed action profile. The pre-configured action profile may be accessed from a database communicatively coupled to the communication node and/or the response action may comprise a database transaction.

The mobile communication device according to the technology disclosed may be a smartphone, but may also be a watch or glasses, configured to determine the signal strength of a broadcast signal or message received from a sensor device, where the signal or message is broadcasted from the sensor device in response to a trigger event such as the activation of an input means of the sensor device or in response to the sensor device obtaining a pre-defined threshold value by at least one of continuously measuring, detecting or recording at least one parameter related to at least one of temperature, pressure, luminance, particles in medium, movement and acceleration.

The mobile communication device according to the technology disclosed may be a smartphone, but may also be a watch or glasses, configured to determine the signal strength of a broadcast signal or message received from a sensor device, where the signal or message is broadcasted from the sensor device in response to a trigger event such as the activation of an input means of the sensor device or in response to the sensor device obtaining a pre-defined threshold value by at least one of continuously measuring, detecting or recording at least one parameter related to at least one of temperature, pressure, luminance, particles in medium, movement and acceleration.

In certain embodiments, the method and system according to the technology disclosed requires that users have an application program (APP) installed on their mobile communication devices. According to certain embodiments of the technology disclosed, a message sent from each of one or more mobile communication devices may include data or information indicating an application program identifier of the respective mobile communication device. In certain embodiments, the sensor device may then be configured to broadcast a signal or message and the respective application program of the one or more mobile communication devices may then be configured to catch the broadcasted message. Each application program that catches the broadcasted message may then be configured to send another second message to a communication node, e.g. a server instance, including information about the broadcasted message and the determined, by the application program/smartphone, signal strength of the received broadcasted message. In other embodiments, a signal or message sent from the sensor device to a communication node, e.g. a server, gateway or hub, may include an application program (APP) identifier of the mobile communication device determined, by the sensor device, to be closest to the sensor device.

In accordance with certain aspects, there is disclosed a method for determining which mobile communication device and associated user is closest to a sensor device at least partly based on a determined signal strength of at least one broadcast signal transmitted by a s sensor device and received by at least one mobile communication device. The method comprises the steps of: receiving at the at least one mobile communication device through a short-range wireless connection or communication, a broadcast signal containing the identity of the sensor device transmitting the broadcast signal and, in response to receiving the broadcast signal and measuring the signal strength of the broadcast signal, transmitting from the at least one mobile communication device a message containing the identity of the transmitting mobile communication device, the measured signal strength and an identity of the sensor device.

In embodiments, the method may further include determining, by at least one of a sensor device and a communication node of the system receiving the message from the at least one mobile communication device, which mobile communication device among a plurality of mobile communication device is closest to the sensor device at least partly based on the signal strengths received from the respective mobile communication device. In certain embodiments, a signal strength value received from a first mobile communication device by the sensor device or the communication node of the system may exceed a certain pre-defined signal strength threshold value. The sensor device or the communication node may then determine that the first mobile communication device is closest to the sensor device based on the information that the signal strength value is exceeding the pre-defined signal strength threshold value. The method may further include that the mobile communication device determined by either the communication node or sensor device to be closest to the sensor device, or at least one user associated the mobile communication device determined to be closest to the sensor device, is provided with information associated with sensor device, e.g. product-related information associated with the sensor device.

In certain embodiments, the mobile communication device determined to be closest to the sensor device at least partly based on at least one signal strength values received by the either the communication node or sensor device of the system. Following the determination of which mobile communication device is closest to sensor device, the methods and system according to the technology disclosed may perform at least one of:
sending, from a communication node or a server instance communicatively coupled to a communication node of the system, a push message to the mobile communication device determined by the communication node to be the closest mobile communication device to the sensor device;
establishing a connection or temporary communication session between the communication node and the mobile communication device determined by the communication node to be the closest mobile communication device to the sensor device, wherein the establishing of the connection or temporary communication session is initiated by the communication node sending a wireless connection request to the mobile communication device;
sending, from the communication node, a response message to the mobile communication device determined by the communication node to be the closest mobile communication device to the sensor device, wherein the response message is sent over an already established connection or temporary communication session between the communication node and the mobile communication device determined by the communication node to be the closest mobile communication device to the sensor device;
extending the period of a timer for an already established connection or temporary communication session between the communication node and the mobile communication device determined by the communication node to be the closest mobile communication device to the sensor device, wherein the connection or temporary communication session was established in connection with sending the message from the mobile communication device to the communication node;
executing, by the communication node, a set of instructions associated with the mobile communication device, or a user associated with the mobile communication device, determined by the communication node to be the closest mobile communication device to the sensor device; and
sending, from the communication node, a token or message to another communication node, wherein the message or token contains a set of instructions or data triggering the other communication node to perform further processing operations associated with the mobile communication device, or a user associated with the mobile communication device, determined by the communication node to be the closest mobile communication device to the sensor device.

In certain embodiments, the technology disclosed relates to a computer-implemented method, the method comprising:
receiving, by a mobile communication device, an input associating the unique identity of a sensor device with an application program of the mobile communication device, the input specifying that the application program shall be invoked when the mobile communication device receives a signal comprising an identifier of a category of sensor devices and/or a unique identifier of the sensor device.

In certain embodiments, the above-mentioned computer-implemented method further comprises at least one of the following actions:
submitting, by the mobile communication device and to a server, a request for information on monitoring whether the mobile communication device has received a broadcast signal from the sensor device;
receiving, by the mobile communication device and from the server, an identifier of a wireless access gateway, the identifier being associated with the sensor device;
registering, by the mobile device, the identifier of the wireless access gateway to the mobile communication device;
monitoring a wireless signal received by the mobile communication device, including determining that the wireless signal is associated with the registered identifier of the wireless access gateway;
notifying the application program of the mobile communication device that the mobile communication device has received a broadcast signal from the sensor device; and
in response, executing the application program.

In embodiments, the technology disclosed relates to a mobile device and a non-transitory storage device storing instructions operable to cause the mobile communication device to perform operations comprising:
receiving, by the mobile device, an input associating the unique identity of a sensor device with an application program, the input specifying that the application program shall be invoked when the mobile device receives a signal comprising an identifier of a category of sensor devices and/or a unique identifier of the sensor device.

The technology disclosed has great potential in a wide range of applications and uses cases, including applications and use cases where the mobile communication device and/or person determined to be closest to a sensor device is provided with product-related information related to a trademark, product or product category associated with, or logically connected to, the sensor device to which the person is determined to be closest to. In some applications, the transmission of the broadcast signal received by the mobile communication device from the sensor device may have been triggered by the person closest to the sensor device activating an input means of the sensor device, e.g. by pushing a button of the sensor device. Applications and uses cases include when a person in a shoe store gets a notification to his mobile communication device in response to pushing a button of the sensor device, putting a product associated with the sensor device in a digital shopping basket in response to pushing a button of the sensor device, renting a bicycle in response to pushing a button, receive a discount in response to activating an input means of the sensor device etcetera.

Various other applications and use cases where the technology disclosed may be used include obtaining information related to a product associated with the sensor device by activating an input means of the sensor device, the downloading of a digital copy of a brochure instead of taking a printed version which is triggered by pushing a button associated with a sensor device, activating an input means associated a certain location such as a restaurant table to order food, drinks or to indicate to the staff at the restaurant that you want a receipt or wish to pay for a meal/drinks.

Other applications and uses cases where the technology disclosed may be used include to activate an input means to freely share the information that you are at a certain location, instead of having passive location tracking which may be intruding or have privacy concerns, to receive a discount code for a product associated with the sensor device, e.g. by proving that you have the application program installed and/or are a registered member, geotagging applications, e.g. to authentically prove that you are at a location/position associated with the sensor device, to activate an input means at the exhibitor's booth to share your contact details with the exhibitor etcetera.

The applications and uses cases where the technology disclosed may be used may require installing an application program (APP) on the mobile communication devices of the users but are not limited to mobile communication device having an application program (APP) installed thereon, e.g. various applications for the technology disclosed may include automatic systems and operating systems, e.g. the solutions according to the technology disclosed may be built into the Android operating system. In example embodiments, the operating system of the mobile communication devices may be configured to catch the broadcasted message from the sensor device and each operating system of the mobile communication device catching the broadcasted message may then be configured to send a response message to either the sensor device or a message to a communication node, e.g. a server instance.

According to embodiments of the technology disclosed for applications where installing an application program (APP) on the mobile communication devices is not required, the message sent from each of the at least one mobile communication device may then include data or information indicating the identity of each mobile communication device and the determined, by the operating system/mobile communication device, signal strength of the broadcasted signal received from the sensor device. The user associated with the mobile communication device determined by either the communication node or sensor device to be closest to the sensor device is then provide with information associated with the sensor device, e.g. the system may be configured to provide a certain user with information associated with the sensor device in response to determining that the mobile communication device associated with that particular user is closest to the sensor device. The determining of which mobile communication device is closest to the sensor device is then first at least partly based on the signal strength of at least one broadcast signal determined by the communication node or the sensor device.

In embodiments where installing an application program (APP) on the mobile communication devices is required, the application program of the mobile communication device may be configured to be invoked or notified when the mobile device receives the short-range wireless broadcast signal or message from the sensor device.

The short-range wireless broadcast signal/message transmitted by the sensor device according to the technology disclosed may, for example, be a Bluetooth signal/message, a Zigbee signal/message, or any other suitable protocol with a broadcast function for transmitting short-range wireless broadcast signals/messages/advertisements.

In certain embodiments of the technology disclosed, the sensor device is configured transmit a short-range wireless broadcast signal/message in the form of a Bluetooth broadcast signal/message and mobile communication devices are configured to receive the Bluetooth broadcast signal from the sensor device.

In certain embodiments of the technology disclosed, the sensor device is configured transmit a short-range wireless broadcast signal/message in the form of a Zigbee broadcast signal/message and mobile communication devices are configured to receive the Zigbee broadcast signal from the sensor device.

Zigbee is an IEEE 802.15.4-based specification for a suite of high-level communication protocols used to create personal area networks with small, low-power digital radios, such as for home automation, medical device data collection, and other low-power low-bandwidth needs, designed for small scale projects which need wireless connection. Hence, Zigbee is a low-power, low data rate, and close proximity (i.e., personal area) wireless ad hoc network.

The technology defined by the Zigbee specification is intended to be simpler and less expensive than other wireless personal area networks (WPANs), such as Bluetooth or more general wireless networking such as Wi-Fi. Applications include wireless light switches, home energy monitors, traffic management systems, and other consumer and industrial equipment that requires short-range low-rate wireless data transfer. Its low power consumption limits transmission distances to 10-100 meters line-of-sight, depending on power output and environmental characteristics. Zigbee devices can transmit data over long distances by passing data through a mesh network of intermediate devices to reach more distant ones. Zigbee is typically used in low data rate applications that require long battery life and secure networking (Zigbee networks are secured by 128 bit symmetric encryption keys.) Zigbee has a defined rate of 250 kbit/s, best suited for intermittent data transmissions from a sensor or input device.

Bluetooth is a short-range wireless technology standard that allows data to be exchanged between fixed and mobile devices. The technology uses short wavelength radio waves from 2.4 to 2.485 GHz. Unlike other forms of connectivity such as wi-fi or 4G, Bluetooth carries connections between devices and other devices as opposed to carrying data to and from the internet.

BLE stands for Bluetooth Low Energy and is a form of wireless communication designed especially for short-range communication. BLE is very similar to Wi-Fi in the sense that it allows devices to communicate with each other. BLE is designed for situations where battery life is preferred over high data transfer speeds.

Bluetooth sensor devices are hardware transmitter—a class of Bluetooth Low Energy (BLE) devices that broadcast their identifier to nearby portable electronic devices. The technology enables devices such as smartphones, tablets and other mobile communication devices to perform actions and receive information, e.g. product-related information, when in close proximity to the sensor device.

Bluetooth sensor devices may use BLE proximity sensing to transmit a universally unique identifier which is picked up by a compatible mobile application (APP) or operating system of a mobile communication device. The identifier and several bytes sent with it can be used to determine the device's physical location, track customers, or trigger a location-based action on the device such as a check-in on social media or a push notification. The frequency of iBeacon transmissions depends on the configuration of the sensor device and can be altered using device specific methods. Both the rate and the transmit power have effect on the sensor device battery life.

An aspect of the technology disclosed is a method in which an identification message is sent from a sensor device, over a wireless communication network, in response to a trigger event sensed by a sensor comprised in the sensor device. The identification message comprises a unique identifier of the sensor device. The identification message is received by at least one mobile communication device which determines the signal strength of the identification message. Each of the at least one mobile communication device in turn sends a second message which is received at a communication node, e.g. a network server. The second message comprises the unique identifier of respective mobile communication device and the respective determined signal strength value. Following the determination by the network server which mobile communication device is closest to the sensor device, a pre-configured action profile associated with the unique identifier in the received message from the mobile communication device determined to be closest to the sensor device is accessed by the network server. The network server causes a response action to be executed based on information in the accessed action profile.

A second aspect of the present disclosure is a sensor device that comprises a sensor device configured to sense a trigger event. The sensor device further comprises a wireless transmitter configured to send an identification message, e.g. a broadcast signal, over a wireless communication network to a network server in response to the trigger event sensed by sensor device. The identification message consists of a unique identifier of the sensor device.

A third aspect of the present disclosure is a network server that comprises at least one processor and at least one memory including computer program code. The at least one memory and the computer program code are configured to, with the at least one processor, cause the network server at least to perform:
receiving an identification message sent by at least one mobile communication device over a wireless communication network in response to receiving a broadcast signal which is triggered by a trigger event sensed by a sensor comprised in a sensor device, wherein the identification message contains a unique identifier of the respective mobile communication device an application program of the respective mobile communication device;
accessing a pre-configured action profile associated with the unique identifier in the received identification message in the event a signal strength value contained in the identification message is indicating that a mobile communication device is the closest mobile communication device to the sensor device, wherein the pre-configured action profile is accessed in the event a signal strength value exceeds a pre-defined threshold value or is higher than a determined signal strength value received by the network server from at least one other mobile communication device; and
causing a response action to be executed based on information in the accessed action profile.

A fourth aspect of the present disclosure is a method in which a physical non-semantic binary event is triggered. A semantic state machine is then controlled with the triggered physical non-semantic binary event.

In an embodiment of the technology disclosed, the response action performed by the communication node, e.g. a network server, comprises a database transaction.

In an embodiment of the technology disclosed, the response action performed by the communication node, e.g. a network server, comprises generating an action message based on information in the accessed action profile, and sending the generated action message to a network node based on the information in the accessed action profile.

In an embodiment of the technology disclosed, at least one other communication node or network server is configured to receive the generated action message, and in case a request is included in the received action message, to comply with the request. The request may then comprise a database transaction.

In an embodiment of the technology disclosed, the sensor of the sensor device may be semiconductor based, and the sensed trigger event comprises a trigger event measurable with a semiconductor-based sensor device.

In an embodiment of the technology disclosed, the sensed trigger event relates to at least one of: touching the sensor device, illumination in proximity of the sensor device, temperature in proximity of the sensor device, position of the sensor device, acceleration of the sensor device, compass heading of the sensor device, velocity of the sensor device, and motion in proximity of the sensor device.

In an embodiment of the technology disclosed, an action message generated and transmitted in response determining which mobile communication device is closest to the sensor device comprises at least one of a service request, an emergency call, a toggle request, and a notification such as a counter notification.

In an embodiment of the technology disclosed, the sensor device comprises a button, and the trigger event consists of touching and pushing the button and the action message generated and transmitted to the mobile communication device in response determining, by the communication node or the sensor device, which mobile communication device is closest to the sensor device comprises at least one of a service request, an emergency call, a toggle request, and a counter notification.

In embodiments of the technology disclosed, the sensed trigger event relates to at least one of illumination in proximity of the sensor device, temperature in proximity of the sensor device, position of the sensor device, acceleration of the sensor device, compass heading of the sensor device, velocity of the sensor device, and motion in proximity of the sensor device.

In an embodiment of the technology disclosed, the sensor device comprises one of a computing device with a touch screen and a computing device with a non-touch screen; and the trigger event consists of one of touching an object drawn on the touch screen and clicking an object drawn on the non-touch screen, respectively.

In an embodiment of the technology disclosed, the action message comprises one of a text messaging service message, an electronic mail message, and a hypertext transfer protocol-based message.

In an embodiment of the present disclosure, the graphic user interface is configured to be accessed via at least one of an internet browser and a mobile communication device application.

In an embodiment of the present disclosure, the information in the action profile comprises recipient data, content of the action message, and a type of the action message.

In an embodiment of the present disclosure, the sensor device is further configured to receive a feedback message, and to provide a feedback signal in response to the received feedback message. The feedback signal may comprise at least one of a light signal and a sound signal.

In an embodiment of the present disclosure, an acknowledgement message is sent by the sensor device in response to the received feedback message.

In an embodiment of the present disclosure, the information in the action profile defines the response action to be executed based on at least one of frequency, amount and lack of received identification messages.

In an embodiment of the present disclosure, the communication node, e.g. a network server, is further configured to receive one or more feedback messages, and the information in the action profile defines the response action to be executed based on at least one of frequency, amount and lack of received feedback messages.

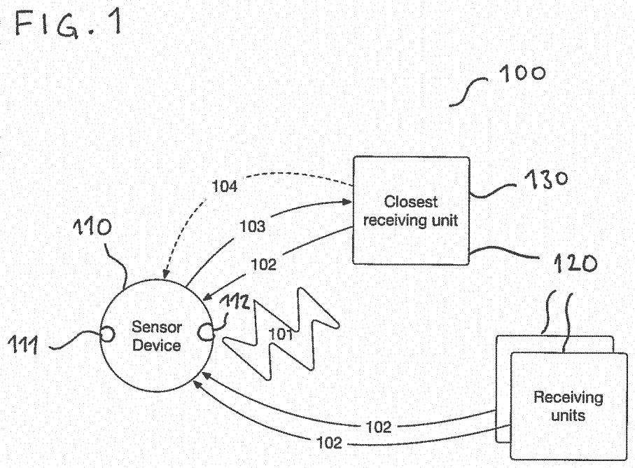

FIG. 1 illustrates a system 100 according to embodiments of the technology disclosed. The system 100 comprises a sensor device 110 that is configured to send a broadcast signal or message 101 over a wireless communication network in response to a trigger event sensed by a sensor 111 comprised in the sensor device 110. The trigger event may be activated by at least one of activation of an input means of the sensor device 110 or obtaining a pre-defined threshold value by at least one of continuously measuring, detecting and recording by the sensor device 110. The sensor device 110 may comprise a sensor 111 that is configured to sense the trigger event. Furthermore, the sensor device 110 comprise at least one wireless transmitter 112 that is configured to send a broadcast signal or message over a wireless communication network to receiving units 120, e.g. mobile communication devices, in response to the trigger event sensed by the sensor 111 of the sensor device 110.

According to an embodiment, the sensor device 110 illustrated in FIG. 1 is configured to broadcast a message 101 and then listen to responses 102 from receiving units 120 and when the responses 102 include a number that relates to factors including at least one of a determined distance to the sensor device 110 by measurements by means of phase and the signal strength that the receiving unit perceived the sensor device's broadcasted message 101. Based on these numbers, the sensor device 110 in FIG. 1 is configured to determine which of the receiving units that is closest to itself and then send a message to a communication node (not shown) or only to the receiving unit determined to be closest to the sensor device 130.

Furthermore, the sensor device 110 may comprise a feedback unit (not shown) that is configured to receive a feedback message, and to provide a feedback signal in response to the received feedback message. The feedback signal may comprise e.g. a light signal and/or a sound signal. The feedback message may be sent e.g. by the communication node (not shown) receiving the action message or the recipient. The feedback message may be transmitted to the sensor device 110 via the communication node or directly to the sensor device 110. For example, in case of a request for a taxi/cab, the taxi center may send a feedback message indicating successful receipt of the request, and the sensor device 110 may then provide e.g. a predetermined light and/or sound signal indicating successful receipt of the request to the person(s) who sent the request.

The broadcast signal consists of a unique identifier of the sensor device 110. The unique identifier may be e.g. a string of alphanumeric characters. The sensor device 110 may be semiconductor based, and the trigger event may comprise a trigger event that can be measured with a semiconductor-based sensor device. For example, trigger event may relate to at least one of: touching the sensor device 110, illumination in proximity of the sensor device 110, temperature in proximity of the sensor device 110, position of the sensor device 110, acceleration of the sensor device 110, compass heading of the sensor device 110, velocity of the sensor device 110, and motion in proximity of the sensor device 110.

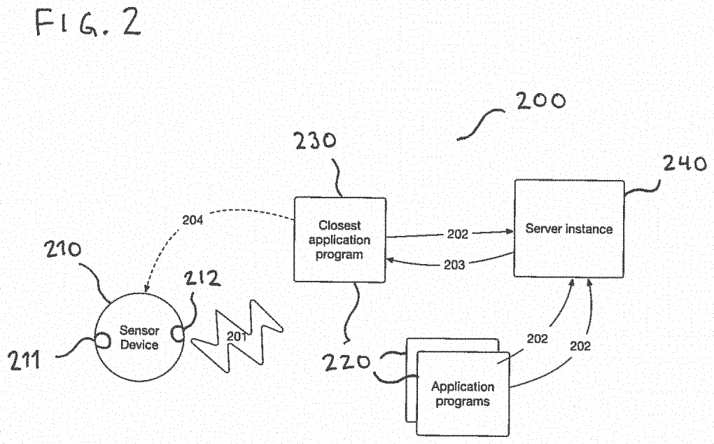

FIG. 2 illustrates a system 200 according to embodiments of the technology disclosed where the system comprises a sensor device 210, a server instance 230, or communication node, and a plurality of mobile communication devices, each of the mobile communication devices comprising an application program 210. The sensor device in FIG. 2 is configured to at least one of transmit one or a plurality of short-range wireless broadcast signals. Each one of the mobile communication devices is configured to receive a short-range wireless broadcast signal from the sensor device 210, and wherein each of the one or more mobile communication devices is further configured to determine the distance by means of measurement by means of phase and/or the signal strength of the received short-range wireless broadcast signal and further to send, to the server instance 230, a message containing data or information indicating the determined signal strength and at least one of the unique identification data of the respective mobile communication device, the unique identification data of a user associated with the respective mobile communication device and the unique application program identifier of the respective mobile communication device.

In embodiments, the system 200 comprises a sensor device 210 that may be configured to send a broadcast signal or message over a wireless communication network in response to a trigger event sensed by a sensor comprised in the sensor device 210. The trigger event may be activated by at least one of activation of an input means of the sensor device 210 or obtaining a pre-defined threshold value by at least one of continuously measuring, detecting and recording by the sensor device 210. The sensor device 210 may comprise a sensor 211 that is configured to sense the trigger event. Furthermore, the sensor device 210 comprise at least one wireless transmitter 212 that is configured to send a broadcast signal or message over a wireless communication network to receiving units (not shown), e.g. mobile communication devices, in response to the trigger event sensed by the sensor 211 of the sensor device 210.

In the system according to embodiments illustrated in FIG. 2, the mobile communication devices each comprise an application program (APP) 220. The sensor device 210 may be configured to broadcast a message and the respective application program 220 of the mobile communication devices catches the broadcasted message. Each application program 220 that catches the broadcasted message may then be configured to send another message to the server instance 230 including information about the broadcasted message and the determined, by the application program/smartphone, distance by means of measurement by means of phase and/or the signal strength of the received broadcasted message. An algorithm used by the server instance 240 may be configured to use the information sent from all mobile communication devices/application programs 220 to determine which application program/smartphone 220 is closest in proximity to the sensor device 210. The server instance 240 may then be configured to send a message to the application program that the algorithm determined to be closest in proximity to the sensor device 230.

The system 200 illustrated in FIG. 2 comprises a sensor device 210, a plurality of application programs 220 and a server instance 230. The sensor device 210 broadcasts a message 201 and the application programs 220 catches the broadcasted message 201. Each application program 220 that catches the broadcasted message sends another message 202 to the server instance 240 including information about the broadcasted message and the signal strength that the application program perceived the broadcasted message 201. An algorithm in the server instance 240 may be use the information sent from all mobile communication devices/application programs to determine which application program 220 is closest in proximity to the sensor device 210. The server instance 240 may also be configured to then sends a message to the application program that its algorithm determined to be closest in proximity to the sensor device 230.

The system 200 illustrated in FIG. 2 comprises a sensor device 210, a server instance 240 and a plurality of mobile communication devices, each comprising an application program 220. The sensor device 210 is configured to at least one of transmit one or a plurality of short-range wireless broadcast signals and the plurality of mobile communication devices are configured to receive the short-range wireless broadcast signal from the sensor device 210. In embodiments, each of the mobile communication devices is further configured to determine the signal strength of the received short-range wireless broadcast signal and further to send, to said communication node, a message containing data or information indicating the determined signal strength and at least one of the unique identification data of the respective mobile communication device, the unique identification data of a user associated with the respective mobile communication device and the unique application program identifier of the respective mobile communication device. The server instance 240 in FIG. 2 may be configured to receive a message from the respective one or more mobile communication devices and identify at least one of a unique application program identifier and the unique identity of the respective one or more mobile communication device. The server instance 240 may be further configured to determine which mobile communication device is closest to the sensor device 210 at least partly based on data or information received in a message from the respective one or more mobile communication devices providing an indication of the determined signal strength of a short-range wireless broadcast signal and/or a determined distance to the sensor device 210 which is measured by means of phase difference between at least two broadcast signals with different frequencies which are transmitted by the sensor device 210.

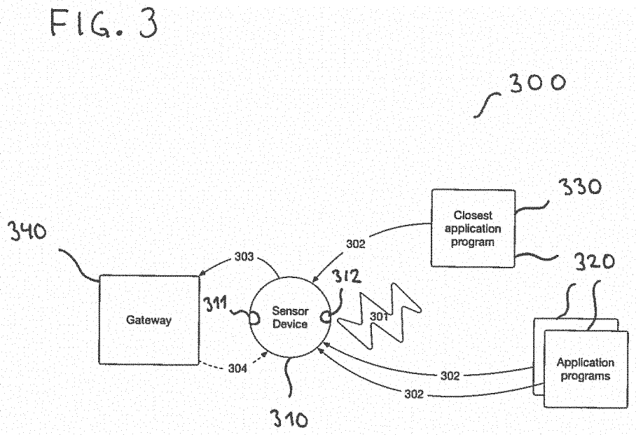

FIG. 3 illustrates a system 300 where the sensor device 310 and its button 311 is connected to a hub/gateway 340, and where the sensor device 310 wants to know which mobile communication device is closest and then send that info to the hub/gateway 330 so that the hub can execute different actions depending on who pushed the button. Furthermore, the sensor device 310 comprises at least one wireless transmitter 312 that is configured to send a broadcast signal or message (301) over a wireless communication network to receiving units (not shown), e.g. mobile communication devices, in response to the trigger event sensed by the sensor 311 of the sensor device 310.

In FIG. 3, the system, comprising a sensor device 310, a plurality of mobile communication devices each comprising an application program 320 and a gateway unit 340. The sensor device 310 in FIG. 3 sends out a broadcast message (301) that the application program receives and then answers with a message (302) containing a number that is calculated by an algorithm that takes the signal strength of the sensor device's broadcast message (301) that the application program perceive and/or the distance to the sensor device 310 measured by means of phase of at least two broadcast signals having different frequencies, as an input. The sensor device 310, upon receiving answers (302) from one or more application programs, compares the numbers in each response and then sends a message (303) to the hub/gateway 340 containing the application program identifier of the application program 320 that had the highest number in its response, suggesting which application program perceived the higher signal strength of the sensor device. The hub/gateway 340, upon receiving the message (303) from the sensor device 310, executes a set of instructions that is determined by which application program identifier that it receives from the sensor device 310.

In embodiments, an algorithm in the gateway unit 340 may be use the information sent from all mobile communication devices/application programs to determine which application program 320 is closest in proximity to the sensor device 310. The server instance 340 may also be configured to then sends a message to the application program that its algorithm determined to be closest in proximity to the sensor device 330.

In certain embodiments, the sensor device 110, 210, 310 may comprise a button 111, 211, 311. In this case, the trigger event may consist of pushing the button 111, 211, 311. Further in this case, the sensor device 110, 210, 310 may comprise e.g. a switch arrangement responsive to the button 111, 211, 311. Further in this case, a feedback unit (not shown) may be further configured to send an acknowledgement message in response to the received feedback message. For example, when the user of the sensor device 110, 210, 310 sees/hears the feedback signal, he/she may press the button 111, 211, 311 again during the feedback signal, and this causes the acknowledgement message to be sent from the sensor device 110, 210, 310 and forwarded to a network node and/or the recipient.

Alternatively, the sensor device 110, 210, 310 may comprise a computing device (e.g. a smart phone or a tablet computer) with a touch screen. In this case, the trigger event may consist of touching an object drawn on the touch screen. In yet another embodiment, the sensor device 110, 210, 310 may comprise a computing device (e.g. a laptop computer or a desktop computer) with a non-touch screen. In this case, the trigger event may consist of clicking, e.g. with a mouse, an object drawn on the non-touch screen.

In embodiments, the system 100, 200, 300 further comprises a communication node (240, 340 that is configured to receive a message including a determined broadcast signal strength value, or a distance to the sensor device which is measured by the mobile communication device by means of phase by comparing broadcast signals having different frequencies, from at least one mobile communication device, determine which mobile communication device is closest to the sensor device at least partly based on the signal strength value(s), access a pre-configured action profile, i.e. a data set, associated with the unique identifier in the received identification message received from the mobile communication device determined by the communication node 240, 340 to be closest to the sensor device, and cause a response action to be executed based on information in the accessed action profile.

The response action may comprise a database transaction. Alternatively/additionally, the response action may comprise generating an action message based on information in the accessed action profile, and sending the generated action message to a communication node 240, 340 and/or based on the information in the accessed action profile.

In accordance with certain embodiments of the technology disclosed, the communication node 240, 340 may comprise at least one processor and at least one memory including computer program code. The at least one memory and the computer program code are configured to, with the at least one processor, cause the communication node 240, 340 at least to perform:
receiving the identification message sent by the at least one mobile communication device over a wireless communication network in response to a trigger event sensed by the sensor comprised in the sensor device 110, 210, 310, the identification message consisting of a unique identifier of the respective mobile communication device;
accessing a pre-configured action profile associated with the unique identifier in the received identification message; and
causing a response action to be executed based on information in the accessed action profile.

In certain embodiments of the technology disclosed, the action message may be in the form of a text messaging service message, an electronic mail message, or a hypertext transfer protocol-based message. Examples of the text messaging service message include short message service (SMS) messages and multimedia messaging service (MMS) messages. Examples of the hypertext transfer protocol-based message include Facebook posts, Twitter tweets, and a http-request to a given system.

Content wise, the action message may comprise at least one of a service request, an emergency call, a toggle request, and a counter notification. Examples of the service request include a request for a taxi/cab (e.g. an SMS to a taxi center), a request for a delivery pick-up (e.g. an SMS to a logistics company ordering system), and a pizza order (e.g. an SMS to a pizzeria). Examples of the emergency call include a help request from an elderly person (e.g. an SMS to a relative or a caretaker or a nurse). Examples of the toggle request include a request to switch a car heater on/off, a request to switch car lights on/off, a request to switch a locking system on/off, a request to switch sauna heating on/off, and IFTTT (www.ifttt.com)-related messages used to switch a given event on/off. Examples of the counter notification include a customer counter at a shop or a visitor counter at a sightseeing attraction, e.g. visitors may press the button 111, 211, 311 to register their visit and the operator of the sightseeing attraction may then use the accumulated visitor counter data for reports, statistics, etc.

Furthermore, the information in the action profile may define the response action to be executed based on at least one of frequency, amount and lack of received identification messages.

Alternatively/additionally, the communication node 240, 340 may be further configured to receive one or more feedback messages, and the information in the action profile may define the response action to be executed based on at least one of frequency, amount and lack of received feedback messages. For example, the information in the action profile may include definitions for use in case the button 111, 211, 311 is not pressed by a predefined time or within a predefined time period.

Alternatively/additionally, the information in the action profile may include definitions for use in case a recipient and/or a network node does not send a feedback message. In such a case, the action profile may e.g. define an alternative recipient for a re-transmission.

Alternatively/additionally, the information in the action profile may include definitions for use in case a predefined amount of identification messages has been received. For example, the response action may be caused to be executed only after the predefined amount of identification messages has been received.

Alternatively/additionally, the information in the action profile may include definitions for use in case a predefined amount of feedback messages has been received.

Alternatively/additionally, the information in the action profile may include definitions for use in case feedback messages have been received from a predefined amount of recipients/network nodes (e.g. in a voting application).

The system 100 may further comprise one or more communication nodes 240, 340 which are configured to receive the generated action message, and in case a request is included in the received action message, to comply with the request. Examples of the network nodes include an email server, a Twitter related network node, such as a server, an IFTTT related communication node 240, 340, such as a server, and a short message service center (SMSC).

The system 100, 200, 300 may further comprise a graphic user interface that is configured to enable editing of the information in the action profile. The graphic user interface may be accessed e.g. via an internet browser (running e.g. on a laptop computer or a desktop computer) and/or a mobile device application (running e.g. on a smart phone or a tablet computer). The information in the action profile may comprise e.g. recipient data, content of the action message, and a type of the action message. The information in the action profile is edited by the user/owner of the sensor device 110, 210, 310 so that he/she can e.g. self-configure the action message to his/her liking.

The exemplary embodiments can include, for example, any suitable servers, workstations, PCs, laptop computers, other devices, and the like, capable of performing the processes of the exemplary embodiments. The devices and subsystems of the exemplary embodiments can communicate with each other using any suitable protocol and can be implemented using one or more programmed computer systems or devices.

It is to be understood that the exemplary embodiments are for exemplary purposes, as many variations of the specific hardware used to implement the exemplary embodiments are possible, as will be appreciated by those skilled in the hardware and/or software art(s). For example, the functionality of one or more of the components of the exemplary embodiments can be implemented via one or more hardware and/or software devices.

The exemplary embodiments can store information relating to various processes described herein. This information can be stored in one or more memories, such as a hard disk, optical disk, magneto-optical disk, RAM, and the like. One or more databases can store the information used to implement the exemplary embodiments of the present disclosure. The databases can be organized using data structures (e.g., records, tables, arrays, fields, graphs, trees, lists, and the like) included in one or more memories or storage devices listed herein. The processes described with respect to the exemplary embodiments can include appropriate data structures for storing data collected and/or generated by the processes of the devices and subsystems of the exemplary embodiments in one or more databases.

All or a portion of the exemplary embodiments can be conveniently implemented using one or more general purpose processors, microprocessors, digital signal processors, micro-controllers, and the like, programmed according to the teachings of the exemplary embodiments of the present disclosure, as will be appreciated by those skilled in the computer and/or software art(s). Appropriate software can be readily prepared by programmers of ordinary skill based on the teachings of the exemplary embodiments, as will be appreciated by those skilled in the software art. In addition, the exemplary embodiments can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware and/or software.

In certain embodiments, the technology disclosed relates to a system, comprising:
a sensor device comprising a sensor device configured to sense a trigger event related to at least one of touching the sensor device, illumination in proximity of the sensor device, temperature in proximity of the sensor device, position of the sensor device, acceleration of the sensor device, compass heading of the sensor device, velocity of the sensor device, and motion in proximity of the sensor device, and configured to send at least one broadcast signal in sequence over a wireless communication network in response to a single sensed trigger event without requiring further user interaction, the at least one broadcast signal consisting of a unique identifier of the sensor device;
at least one mobile communication device configured to receive the broadcast signal, determine the signal strength of the broadcast signal, and transmitting an identification message comprising the determined signal strength and a unique identifier of the mobile communication device; and
a network server, configured to receive the identification message from the mobile communication device and determine whether the mobile communication device is the closest mobile communication device at least partly based on the signal strength of the broadcast signal, access a pre-configured action profile associated with the unique identifier of the mobile communication device in the received identification message, and cause a response action to be executed based on information in the accessed action profile, wherein the response action comprises generating an action message based on information in the accessed action profile, and sending the generated action message to a network node based on the information in the accessed action profile.

In embodiments, the technology disclosed relates to methods, a sensor device, a communication node and a system allowing for a person activating an input means of a sensor device to obtain information associated with the sensor device, e.g. obtain information related to a certain product, trademark and/or category of products associated with the sensor device. Example applications include a user having a certain application program (APP) installed on his/her smartphone who is pushing a button of a sensor device in a shoe store may get a notification to his/her smartphone describing the product, e.g. which sizes a shoe associated with the sensor device is available in.

In embodiments, the technology disclosed relates to methods, a sensor device, a communication node and a system for providing information to the user of a mobile communication device in response to obtaining a pre-defined threshold value where the pre-defined threshold value is at least one of determined, measured, detected or recorded by the sensor device. Example applications include a temperature sensor which is configured to transmit a signal in response to sensing a temperature value falling below a pre-defined temperature value and where the user closest to the sensor device is notified about the drop in temperature. Other example applications include a motion sensor detecting presence of a moving object and where the guard closest to the motion sensor is notified about the presence of the moving object.

In embodiments, the technology disclosed relates to methods, a sensor device, a communication node and a system for providing information and/or sending a message to a person who interacted with a sensor device, where the determining of which person is closest to the sensor device is at least partly based on a determined signal strength of a signal transmitted from the sensor device and received by a mobile communication device associated with a user or person.

The short-range wireless communication used by the system and sensor device according to the technology disclosed may use a Bluetooth standard, e.g. the short-range wireless broadcast signal or message sent by the sensor device may be a Bluetooth signal, but may also use other types of short-range wireless communications supporting the transmission of advertisements or broadcasts. Other typical examples of short-range wireless communications that may be used in connection with the technology disclosed include Zigbee. sending the generated action message to a network node based on the information in the accessed action profile.

In embodiments, the technology disclosed relates to methods, a sensor device, a communication node and a system allowing for a person activating an input means of a sensor device to obtain information associated with the sensor device, e.g. obtain information related to a certain product, trademark and/or category of products associated with the sensor device. Example applications include a user having a certain application program (APP) installed on his/her smartphone who is pushing a button of a sensor device in a shoe store may get a notification to his/her smartphone describing the product, e.g. which sizes a shoe associated with the sensor device is available in.

In embodiments, the technology disclosed relates to methods, a sensor device, a communication node and a system for providing information to the user of a mobile communication device in response to obtaining a pre-defined threshold value where the pre-defined threshold value is at least one of determined, measured, detected or recorded by the sensor device. Example applications include a temperature sensor which is configured to transmit a signal in response to sensing a temperature value falling below a pre-defined temperature value and where the user closest to the sensor device is notified about the drop in temperature. Other example applications include a motion sensor detecting presence of a moving object and where the guard closest to the motion sensor is notified about the presence of the moving object.

In embodiments, the technology disclosed relates to methods, a sensor device, a communication node and a system for providing information and/or sending a message to a person who interacted with a sensor device, where the determining of which person is closest to the sensor device is at least partly based on a determined signal strength of a signal transmitted from the sensor device and received by a mobile communication device associated with a user or person.

The short-range wireless communication used by the system and sensor device according to the technology disclosed may use a Bluetooth standard, e.g. the short-range wireless broadcast signal or message sent by the sensor device may be a Bluetooth signal, but may also use other types of short-range wireless communications supporting the transmission of advertisements or broadcasts. Other typical examples of short-range wireless communications that may be used in connection with the technology disclosed include Zigbee.

1. A method in a system comprising a sensor device, a communication node and at least one mobile communication device, comprising:
a) transmitting, by said sensor device, at least one short-range wireless broadcast signal;
b) receiving, at one or more mobile communication devices, at least one short-range wireless broadcast signal from said sensor device;
c) determining, by each of said one or more mobile communication devices, at least one of a distance to the sensor device by measurement by means of phase using a plurality of received short-range wireless broadcast signals and the signal strength of at least one received short-range wireless broadcast signal;
d) sending, from each of said one or more mobile communication devices, a message including data or information indicating the respective determined distance and/or signal strength of the short-range wireless broadcast signal;
e) receiving, at the communication node, said message from the respective one or more mobile communication devices; and
f) determining, by said communication node and at least partly based on the received data or information indicating the respective determined distance and/or signal strength received from the one or more mobile communication devices, which mobile communication device is closest to the sensor device.

2. The method according to claim 1, wherein said at least one short-range wireless broadcast signal includes data or information indicating at least one of sensor device category data and the unique identification data of said sensor device.

3. The method according to claim 1, wherein said message sent from each of said one or more mobile communication devices further includes data or information indicating at least one of the following:
a) unique identity of the respective mobile communication device,
b) an application program identifier of the respective mobile communication device,
c) user login identification data associated with the user of the application program of the respective mobile communication device,
d) device category of said sensor device, and
e) unique identification data of said sensor device.

4. The method according to claim 1, further comprising:
activating an input means of said sensor device, wherein said at least one short-range wireless broadcast signal is transmitted by said sensor device in response to said input device being activated.

5. The method according to claim 1, further comprising:
continuously measuring, detecting and/or recording, by the sensor device, at least one of temperature, pressure, luminance, particles in medium, movement and acceleration; and
obtaining a pre-defined threshold value by said continuously measuring, detecting and/or recording;
wherein said at least one short-range wireless broadcast signal is transmitted by said sensor device in response to obtaining said pre-defined threshold value.

6. The method according to claim 1, wherein said determining by said communication node which mobile communication device is closest to the sensor device is at least partly based on the communication node performing the step of:
comparing data or information indicating a determined signal strength of a short-range wireless broadcast signal in a message received from a first mobile communication device, or a distance to the sensor device measured by means of phase, with data or information indicating a determined signal strength of a short-range wireless broadcast signal, or a distance to the sensor device measured by means of phase, in at least one other message received by said communication node from at least one other second mobile communication device.

7. The method according to claim 1, wherein said determining by said communication node which mobile communication device is closest to the sensor device comprises:
determining, which mobile communication device is closest to the sensor device at least partly based on data or information in a message received from a mobile communication device is indicating that the signal strength determined by a mobile communication device exceeds a pre-defined signal strength threshold value or that a distance to the sensor device measured by means of phase is shorter than a pre-defined distance value.

8. The method according to claim 1, wherein a short-range wireless broadcast signal from the sensor device is received by a plurality of mobile communication devices, the method further comprising:
sending, from each of said plurality of mobile communication devices, a message including data or information indicating a determined distance to the sensor device and/or a determined signal strength of a short-range wireless broadcast signal; and
receiving, at said communication node, a message from respective of said plurality of mobile communication devices including data or information indicating the distance to the sensor device and/or signal strength of a short-range wireless broadcast signal determined by the respective mobile communication device; and
determining, by said communication node, which mobile communication device among said plurality of mobile communication device is closest to the sensor device at least partly based on the determined distance and/or signal strength, wherein said determining is at least partly based on comparing data or information indicating a determined distance to the sensor device and/or a signal strength of a short-range wireless broadcast signal in a message received from a first mobile communication device with data or information indicating a determined distance to the sensor device and/or a signal strength of a short-range wireless broadcast signal in at least one other message received by said communication node from at least one other second mobile communication device.

9. The method according to claim 1, the method further comprising at least one of:
sending, from said communication node, a push message to the mobile communication device determined by the communication node to be the closest mobile communication device to the sensor device;
establishing a connection or temporary communication session between said communication node and the mobile communication device determined by the communication node to be the closest mobile communication device to the sensor device, wherein said establishing of said connection or temporary communication session is initiated by said communication node sending a wireless connection request to said mobile communication device;
sending, from said communication node, a response message to the mobile communication device determined by the communication node to be the closest mobile communication device to the sensor device, wherein said response message is sent over an already established connection or temporary communication session between said communication node and the mobile communication device determined by the communication node to be the closest mobile communication device to the sensor device;
extending the period of a timer for an already established connection or temporary communication session between said communication node and the mobile communication device determined by the communication node to be the closest mobile communication device to the sensor device, wherein said connection or temporary communication session was established in connection with sending said message from the mobile communication device to the communication node;
executing, by said communication node, a set of instructions associated with the mobile communication device, or a user associated with the mobile communication device, determined by the communication node to be the closest mobile communication device to the sensor device; and
sending, from said communication node, a token or message to another communication node, wherein said message or token contains a set of instructions or data triggering the other communication node to perform further processing operations associated with the mobile communication device, or a user associated with the mobile communication device, determined by the communication node to be the closest mobile communication device to the sensor device.

10. The method according to claim 1, the system further comprises:
a transmitting device or devices that are configured to transmit a short-range wireless broadcast signal with a predefined wake-up message that the said mobile communication devices receives and upon receiving said wake-up message, temporarily changes parameters of said mobile communication devices that allows the communication devices to listen to short-range wireless broadcast signals from said sensor devices faster than before.

11. A communication node configured to receive a message from one or more mobile communication devices in a system comprising a sensor device, wherein the communication node is further configured to:
determine which mobile communication device is closest to the sensor device at least partly based on data or information received in a message from one or more mobile communication devices providing an indication of a determined distance to the sensor device by measurement by means of phase using at least two wireless broadcast signals having different frequencies and/or a signal strength of a short-range wireless broadcast signal received by the respective one or more mobile communication devices from said sensor device.

12. The communication node according to claim 11, wherein the communication node is further configured to determine which mobile communication device is closest to the sensor device by comparing data or information indicating a determined distance to the sensor device and/or a signal strength of a short-range wireless broadcast signal in a message received from a first mobile communication device with data or information indicating a determined distance to the sensor device and/or a signal strength of a short-range wireless broadcast signal in at least one other message received by the communication node from at least one other second mobile communication device.

13. The communication node according to claim 11, wherein the communication node is configured to determine which mobile communication device is closest to the sensor device at least partly based on data or information in a message received from a mobile communication device is indicating that the signal strength determined by a mobile communication device exceeds a pre-defined signal strength threshold value.

14. The communication node according to claim 11, wherein said communication is further configured to perform at least one of the following actions in response to said determining of which mobile communication device is closest to said sensor device:
sending, from said communication node, a push message to the mobile communication device determined by the communication node to be the closest mobile communication device to the sensor device;
establishing a connection or temporary communication session between said communication node and the mobile communication device determined by the communication node to be the closest mobile communication device to the sensor device, wherein said establishing of said connection or temporary communication session is initiated by said communication node sending a wireless connection request to said mobile communication device;
sending, from said communication node, a response message to the mobile communication device determined by the communication node to be the closest mobile communication device to the sensor device, wherein said response message is sent over an already established connection or temporary communication session between said communication node and the mobile communication device determined by the communication node to be the closest mobile communication device to the sensor device;
extending the period of a timer for an already established connection or temporary communication session between said communication node and the mobile communication device determined by the communication node to be the closest mobile communication device to the sensor device, wherein said connection or temporary communication session was established in connection with sending said message from the mobile communication device to the communication node;
executing, by said communication node, a set of instructions associated with the mobile communication device, or a user associated with the mobile communication device, determined by the communication node to be the closest mobile communication device to the sensor device; and
sending, from said communication node, a token or message to another communication node, wherein said message or token contains a set of instructions or data triggering the other communication node to perform further processing operations associated with the mobile communication device, or a user associated with the mobile communication device, determined by the communication node to be the closest mobile communication device to the sensor device.

15. The communication node according to claim 11, wherein said communication node is a stationary unit in the form of a server, a gateway or a hub.

16. The communication node according to claim 11, wherein said communication node is communicatively coupled to, or associated with, a database configured to store information about at least one of the unique identities of sensor devices, the unique identities of mobile communication devices and the unique identities of users associated with the identities of the mobile communications devices.

17. A system comprising a sensor device, a communication node and at least one mobile communication device, each at least one mobile communication device comprising an application program, said sensor device is configured to at least one of transmit one or a plurality of short-range wireless broadcast signals, wherein each of the at least one mobile communication device is configured to receive a short-range wireless broadcast signal from said sensor device, and wherein
each of the one or more mobile communication devices is further configured to determine at least one of a distance to the sensor device by measurement by means of phase using a plurality of received short-range wireless broadcast signals and the signal strength of the received short-range wireless broadcast signal and further to send, to said communication node, a message containing data or information indicating the determined distance measured by means of phase and/or signal strength and at least one of the unique identification data of the respective mobile communication device, the unique identification data of a user associated with the respective mobile communication device and the unique application program identifier of the respective mobile communication device;
the communication node is configured to receive a message from the respective one or more mobile communication devices and identify at least one of a unique application program identifier and the unique identity of the respective one or more mobile communication device, wherein the communication node is further configured to determine which mobile communication device is closest to the sensor device at least partly based on data or information received in a message from the respective one or more mobile communication devices providing an indication of the determined distance measured by means of phase and/or signal strength of a short-range wireless broadcast signal.

18. The system according to claim 17, wherein the communication node of the system is further configured to determine which mobile communication device is closest to the sensor device by comparing data or information indicating a determined signal strength of a short-range wireless broadcast signal, or a distance to the sensor device measured by means of phase, in a message received from a first mobile communication device with data or information indicating a determined signal strength of a short-range wireless broadcast signal, or a distance to the sensor device measured by means of phase, in at least one other message received by the communication node from at least one other second mobile communication device.

19. The system according to claim 17, wherein the communication node of the system is further configured to determine which mobile communication device is closest to the sensor device at least partly based on data or information in a message received from a mobile communication device is indicating that the signal strength determined by a mobile communication device exceeds a pre-defined signal strength threshold value and/or that a distance to said sensor device measured by means of phase is shorter than a pre-defined distance threshold value.

20. The system according to claim 17, wherein the communication node of the system is further configured to perform at least one of the following actions in response to said determining of which mobile communication device is closest to said sensor device:
sending, from said communication node, a push message to the mobile communication device determined by the communication node to be the closest mobile communication device to the sensor device;
establishing a connection or temporary communication session between said communication node and the mobile communication device determined by the communication node to be the closest mobile communication device to the sensor device, wherein said establishing of said connection or temporary communication session is initiated by said communication node sending a wireless connection request to said mobile communication device;
sending, from said communication node, a response message to the mobile communication device determined by the communication node to be the closest mobile communication device to the sensor device, wherein said response message is sent over an already established connection or temporary communication session between said communication node and the mobile communication device determined by the communication node to be the closest mobile communication device to the sensor device;
extending the period of a timer for an already established connection or temporary communication session between said communication node and the mobile communication device determined by the communication node to be the closest mobile communication device to the sensor device, wherein said connection or temporary communication session was established in connection with sending said message from the mobile communication device to the communication node;
executing, by said communication node, a set of instructions associated with the mobile communication device, or a user associated with the mobile communication device, determined by the communication node to be the closest mobile communication device to the sensor device; and
sending, from said communication node, a token or message to another communication node, wherein said message or token contains a set of instructions or data triggering the other communication node to perform further processing operations associated with the mobile communication device, or a user associated with the mobile communication device, determined by the communication node to be the closest mobile communication device to the sensor device.

21. The system according to claim 17, wherein said sensor device comprises input means, and wherein said sensor device is further configured so that said at least one short-range wireless broadcast signal is transmitted by said sensor device in response to said input device being activated.

22. The system according to claim 17, wherein said sensor device comprises means for continuously measuring, detecting and/or recording at least one of temperature, pressure, luminance, particles in medium, movement and acceleration; and wherein said at least one short-range wireless broadcast signal is transmitted by said sensor device in response to obtaining a pre-defined threshold value.

23. The system according to claim 17, wherein the system further comprises a transmitting device or devices that is/are configured to transmit a short-range wireless broadcast signal with a predefined wake-up message that the said mobile communication devices receives and upon receiving said wake-up message, temporarily changes parameters of said mobile communication devices that allows the communication devices to listen to short-range wireless broadcast signals from said sensor devices faster than before.
